(19) United States
(12) Patent Application Publication
(10) Pub. No.: US 2023/0120921 A1
(43) Pub. Date: Apr. 20, 2023

(54) POWER CONVERSION DEVICE, METHOD OF CONTROLLING POWER CONVERSION DEVICE, AND STORAGE MEDIUM

(71) Applicant: HONDA MOTOR CO., LTD., Tokyo (JP)

(72) Inventors: Yoshinari Tsukada, Wako-shi (JP); Hisaya Oiwa, Tokyo (JP)

(21) Appl. No.: 17/960,851

(22) Filed: Oct. 6, 2022

(30) Foreign Application Priority Data
Oct. 14, 2021 (JP) 2021-168882

(51) Int. Cl. H02M 7/5395; H02J 7/00; B60L 50/51; B60L 50/60

(52) U.S. Cl. CPC H02M 7/5395; H02J 7/0013; B60L 50/51; B60L 50/60; H02J 2310/48

(57) ABSTRACT

A power conversion device includes a power converter including at least a first converter for converting battery power output by a battery into first output power of a first voltage waveform based on an input or set output waveform profile and outputting the first output power from a first terminal pair and a second converter for converting the battery power into second output power of a second voltage waveform of a rectangular shape and outputting the second output power from a second terminal pair and configured to supply a load with third output power of an alternating current (AC) control waveform generated by adding the first output power to the second output power, and a controller configured to output a voltage command value for outputting the first output power as the output waveform profile to the first converter to the power converter on the basis of the input request command value of output power for the load and the voltage value of the third output power output by the power converter.

### CROSS-REFERENCE TO RELATED APPLICATION

Priority is claimed on Japanese Patent Application No. 2021-168882, filed Oct. 14, 2021, the content of which is incorporated herein by reference.

### BACKGROUND OF THE INVENTION

### Field of the Invention

The present invention relates to a power conversion device, a method of controlling the power conversion device, and a storage medium.

### Description of Related Art

Efforts are underway to reduce adverse effects on the global environment (for example, reduction of NOₓ and SOₓ or reduction of CO₂). Thus, in recent years, from the viewpoint of improving the global environment, for reduction of CO₂, there is growing interest in at least electric vehicles allowed to travel with electric motors driven by power supplied by batteries (secondary batteries) such as, for example, a hybrid electric vehicle (HEV) and a plug-in hybrid vehicle (PHEV). The use of a lithium-ion secondary battery as a battery for in-vehicle use is being studied. In these electric vehicles, direct current (DC) power stored in the battery is converted into alternating current (AC) power for driving an electric motor.

In relation to this, for example, PCT International Publication No. WO 2019/004015 and PCT International Publication No. WO 2019/116785 disclose technologies related to power conversion devices for converting DC power into AC power. In the power conversion devices disclosed in PCT International Publication No. WO 2019/004015 and PCT International Publication No. WO 2019/116785, DC power is converted into AC power by performing a control process (a switching control process) for the ON or OFF time of a battery that is a power source using an inverter. The inverter has a simple configuration and has become the most popular power conversion device for adjusting AC power and frequency in recent years.

The conventional bridge-type inverter outputs modulated AC power by performing a process of alternately switching the state of an upper/lower arm to an ON or OFF state. The voltage of a main circuit of the inverter is applied to a switching element (a power semiconductor element) arranged on each arm constituting the inverter when a control process is performed such that it is in the OFF state. Thus, it is necessary to use a high withstand voltage component for a switching element constituting the inverter such that it can withstand a high voltage (a surge voltage) when a control process is performed such that it is in the OFF state in addition to the voltage of the main circuit of the inverter. However, in general, the voltage (an ON voltage) and the withstand voltage in the ON state of a semiconductor element are characteristics determined by the physical properties and structure of the element, and the resistance (ON resistance) of a drift layer is mainly dominant Therefore, in the semiconductor element, the reduction of the ON voltage and the improvement of the withstand voltage are incompatible in principle. Thus, in the inverter, the steady loss due to the ON resistance of the switching element and the loss (switching loss) when the switching element is switched increase in proportion to the increase in the voltage of the main circuit and the efficiency of power conversion as a system of the inverter is reduced. Further, in normal travel of an electric vehicle, a high voltage is not always required, but rather a voltage lower than the battery voltage is often required. That is, during normal travel of an electric vehicle, output power lower than maximum output power in the system of the inverter is often required. In this case, the efficiency of power conversion of the system of the inverter is further reduced.

### SUMMARY OF THE INVENTION

Meanwhile, in a power modulation method based on switching control in the inverter, AC power with a sinusoidal waveform is generated and output. At this time, the conventional inverter converts DC power into AC power by virtually setting an intermediate voltage value of the voltage of the main circuit to 0 [V]. Thus, it is possible to obtain only the effect of a primary low-pass filter due to an inductance component of the electric motor provided in the electric vehicle with AC power having a sinusoidal wave shape generated by the inverter. Thus, when the frequency (switching frequency) of switching control in the inverter or a frequency of an electrical angle in the electric motor (i.e., a rational speed of the electric motor) is low as in the normal travel of an electric vehicle, a harmonic current may be generated according to switching control of the inverter. In this case, in the electric vehicle, the generated harmonic current increases, for example, the iron loss of the electric motor, and becomes another cause that can lower the efficiency of power conversion of the system of the inverter.

In this way, the inverter conventionally used for an electric vehicle as a power conversion device does not have a preferred configuration in which power conversion suitable for characteristics of travel of an electric vehicle can be performed reliably.

The present invention has been made on the basis of the recognition of the above-described problems and an objective of the present invention is to provide a power conversion device, a method of controlling the power conversion device, and a storage medium capable of improving energy efficiency by performing preferred power conversion associated with a battery suitable for characteristics of travel of an electric vehicle.

A power conversion device, a method of controlling the power conversion device, and a storage medium according to the present invention adopt the following configurations.

(1): According to an aspect of the present invention, there is provided a power conversion device including: a power converter including at least a first converter for converting battery power output by a battery into first output power of a first voltage waveform based on an input or set output waveform profile and outputting the first output power from a first terminal pair and a second converter for converting the battery power into second output power of a second voltage waveform of a rectangular shape and outputting the second output power from a second terminal pair and configured to supply a load with third output power of an AC control waveform generated by adding the first output power to the second output power; and a controller configured to output a voltage command value for outputting the first output power as the output waveform profile to the first converter to the power converter on the basis of the input request command value of output power for the load and a voltage value of the third output power output by the power converter.

(2): In the above-described aspect (1), the first voltage waveform is a voltage waveform obtained by subtracting the second voltage waveform from the control waveform represented by a sinusoidal wave having a positive value.

(3): In the above-described aspect (2), the power converter supplies the third output power from a portion between one end of the first terminal pair and one end of the second terminal pair to the load, and the power converter further includes a first switching element connected between another end of the first terminal pair and another end of the second terminal pair and the one end of the first terminal pair and configured to enable or disable the supply of electric power supplied from the load to the first converter and the second converter.

(4): In the above-described aspect (3), the second converter is a half-bridge type converter including: a second switching element connected between the battery and the another end of the second terminal pair and configured to enable or disable the supply of the battery power as the second output power to the load; and a third switching element connected between the one end of the second terminal pair and the another end of the second terminal pair and configured to enable or disable the supply of the second output power to the first converter.

(5): In the above-described aspect (4), the power converter further includes a third converter connected to the first converter and the second converter in parallel and configured to convert the battery power into fourth output power of a third voltage waveform of a rectangular shape and output the fourth output power from a third terminal pair, the first voltage waveform is a voltage waveform from which the third voltage waveform is subtracted, and the third output power generated by adding the first output power and the second output power to the fourth output power is supplied to the load.

(6): In the above-described aspect (5), the power converter supplies the third output power from a portion between the one end of the second terminal pair and one end of the third terminal pair to the load, and the power converter further includes a fourth switching element connected between the one end of the first terminal pair and another end of the third terminal pair and the one end of the third terminal pair and the first switching element and configured to enable or disable the supply of electric power supplied from the load to the first converter and the third converter.

(7): In the above-described aspects (1), the load is a star-connected three-phase load, the power conversion device includes three power converters configured to supply the third output power to each corresponding phase of the load, the power converters have one ends of second terminal pairs connected to each other, and the controller outputs the voltage command value for outputting the third output power of the control waveform that is modulated such that a phase is shifted by 120° to the first converter provided in the power converter corresponding to each phase as the output waveform profile to the power converter.

(8): In the above-described aspect (7), the controller selects a minimum voltage value among voltage values of third output powers corresponding to phases, the controller performs a modulation process in which 0 [V] is a reference modulation voltage value by designating a voltage value obtained by multiplying the selected minimum voltage value by −1 as an offset voltage value and adding the offset voltage value to a voltage value of the third output power, and the controller outputs the voltage command value indicating the modulation voltage value as the output waveform profile to the power converter.

(9): According to an aspect of the present invention, there is provided a method of controlling a power conversion device having a power converter including at least a first converter for converting battery power output by a battery into first output power of a first voltage waveform based on an input or set output waveform profile and outputting the first output power from a first terminal pair and a second converter for converting the battery power into second output power of a second voltage waveform of a rectangular shape and outputting the second output power from a second terminal pair and configured to supply a load with third output power of an AC control waveform generated by adding the first output power to the second output power, the method including; outputting, by a computer, a voltage command value for outputting the first output power as the output waveform profile to the first converter to the power converter on the basis of an input request command value of output power for the load and the voltage value of the third output power output by the power converter.

(10): According to an aspect of the present invention, there is provided a non-transitory computer-readable storage medium storing a program for controlling a power converter including at least a first converter for converting battery power output by a battery into first output power of a first voltage waveform based on an input or set output waveform profile and outputting the first output power from a first terminal pair and a second converter for converting the battery power into second output power of a second voltage waveform of a rectangular shape and outputting the second output power from a second terminal pair and configured to supply a load with third output power of an AC control waveform generated by adding the first output power to the second output power, the program causing a computer to: output a voltage command value for outputting the first output power as the output waveform profile to the first converter to the power converter on the basis of an input request command value of output power for the load and a voltage value of the third output power output by the power converter.

According to the above-described aspects (1) to (10), it is possible to improve energy efficiency by performing preferred power conversion associated with a battery suitable for characteristics of travel of an electric vehicle.

### BRIEF DESCRIPTION OF THE DRAWINGS

FIG. 1 is a diagram showing an example of a configuration of a vehicle in which a power conversion device according to the embodiment is adopted.

FIG. 2 is a diagram showing an example of a configuration of the power conversion device.

FIG. 3 is a diagram showing an example of a configuration of a switching element provided in the power conversion device.

FIG. 4 is a diagram showing an example of a voltage waveform generated in the power conversion device.

FIG. 5 is a diagram showing an example of a detailed timing when a controller provided in the power conversion device controls a power converter and a control process.

FIG. 6 is a diagram showing an example of a configuration of a converter provided in the power conversion device.

FIG. 7 is a diagram showing another example of the configuration of the converter provided in the power conversion device.

FIG. 8 is a diagram showing an example of a functional configuration of a converter controller provided in the converter.

FIG. 9 is a diagram showing an example of a configuration of a controller provided in the power conversion device.

FIG. 10 is a flowchart showing an example of a flow of a process executed in the controller.

FIG. 11 is a diagram showing an example of a configuration of a power conversion device according to a modified example.

FIG. 12 is a diagram showing an example of a voltage waveform generated in the power conversion device of the modified example.

FIG. 13 is a diagram showing an example of a detailed timing when a controller provided in the power conversion device of the modified example controls a power converter and a control process.

FIG. 14 is a diagram showing an example of a control process in which the controller provided in the power conversion device of the modified example controls the power converter.

FIG. 15 is a diagram showing a relationship between voltages applied to a traveling motor provided in a vehicle.

FIG. 16 is a diagram showing a relationship between inter-terminal voltages of the traveling motor provided in the vehicle.

FIG. 17 is a diagram showing an example of a functional configuration of a voltage command value determiner provided in the controller.

FIG. 18 is a diagram showing an example of a functional configuration of a voltage modulator provided in the voltage command value determiner.

FIG. 19 is a diagram showing an example of a voltage waveform generated when a voltage is modulated in the power conversion device.

FIG. 20 is a diagram showing an example of a voltage waveform generated when a voltage is modulated in the power conversion device of the modified example.

### DETAILED DESCRIPTION OF THE INVENTION

Hereinafter, embodiments of a power conversion device, a method of controlling the power conversion device, and a storage medium of the present invention will be described with reference to the drawings. As used throughout this disclosure, the singular forms “a,” “an,” and “the” include a plurality of references unless the context clearly dictates otherwise.

### Configuration of Vehicle

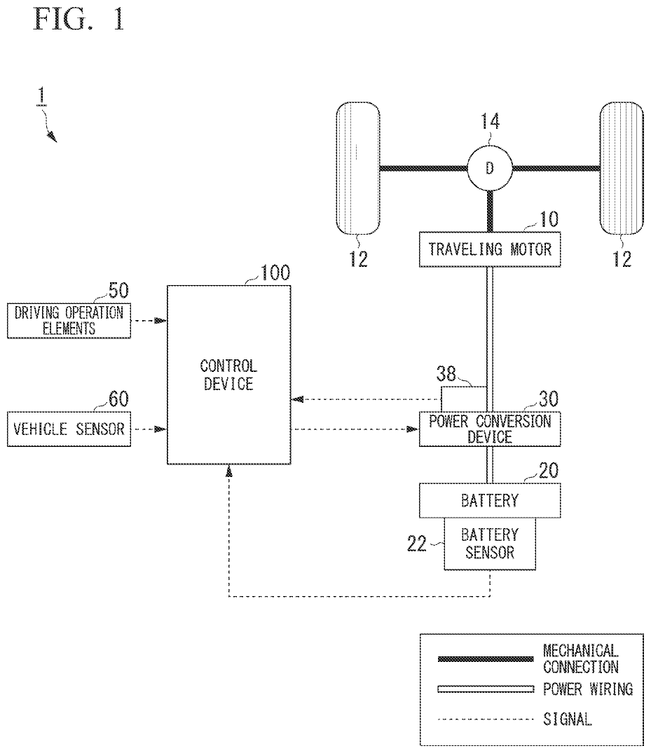

FIG. 1 is a diagram showing an example of a configuration of a vehicle in which a power conversion device according to an embodiment is adopted. A vehicle 1 is an electric vehicle (EV) (hereinafter simply referred to as a “vehicle”) that travels using an electric motor driven with power supplied from a battery (a secondary battery) for traveling. Vehicles to which the present invention is applied include, for example, general vehicles such as four-wheeled vehicles, saddle-riding type two-wheeled vehicles, three-wheeled vehicles (including two front wheel and one rear wheel vehicles in addition to one front wheel and two rear wheel vehicles), and a vehicle that travels using an electric motor driven by power supplied from a traveling battery such as an assisted bicycle. The vehicle 1 may be, for example, a hybrid electric vehicle (HEV) that travels by further combining power supplied according to an operation of an internal combustion engine that uses fuel as an energy source, such as a diesel engine or a gasoline engine.

The vehicle 1 includes, for example, a traveling motor 10, a drive wheel 12, a speed reducer 14, a battery 20, a battery sensor 22, a power conversion device 30, a power sensor 38, driving operation elements 50, a vehicle sensor 60, and a control device 100.

The traveling motor 10 is a rotating electric machine for traveling of the vehicle 1. The traveling motor 10 is, for example, a three-phase AC motor. The rotor of the traveling motor 10 is connected to the speed reducer 14. The traveling motor 10 is driven (rotated) with electric power supplied from the battery 20 via the power conversion device 30. The traveling motor 10 transfers its own rotational power to the speed reducer 14. The traveling motor 10 may operate as a regenerative brake using the kinetic energy during deceleration of the vehicle 1 to generate electric power. The traveling motor 10 is an example of a “load” in the claims.

The speed reducer 14 is, for example, a differential gear. The speed reducer 14 causes a driving force of a shaft to which the traveling motor 10 is connected, i.e., rotational power of the traveling motor 10, to be transferred to an axle to which the drive wheel 12 is connected. The speed reducer 14 may include, for example, a so-called transmission mechanism in which a plurality of gears or shafts are combined to change the rotational speed of the traveling motor 10 in accordance with a gear ratio and cause the rotational speed to be transferred to the axle. The speed reducer 14 may also include, for example, a clutch mechanism that directly connects or separates the rotational power of the traveling motor 10 to or from the axle.

The battery 20 is a battery for traveling of the vehicle 1. The battery 20 includes, for example, a secondary battery capable of being iteratively charged and discharged as a power storage unit such as a lithium-ion battery. The battery 20 may have a configuration that can be easily attached to and detached from the vehicle 1, such as a cassette type battery pack, or may have a stationary configuration that is not easily attached to and detached from the vehicle 1. The secondary battery provided in the battery 20 is, for example, a lithium-ion battery. Although, for example, a lead storage battery, a nickel-hydrogen battery, a sodium-ion battery, or the like, a capacitor such as an electric double layer capacitor, or a composite battery in which a secondary battery and a capacitor are combined can be considered for the secondary battery provided in the battery 20, the secondary battery may have any configuration. The battery 20 stores (is charged with) power introduced from an external charger (not shown) of the vehicle 1 and is discharged to supply the stored power so that the vehicle 1 is allowed to travel. The battery 20 stores (is charged with) the power generated by the traveling motor 10 operated as a regenerative brake supplied via the power conversion device 30 and is discharged to supply the stored power for traveling (for example, accelerating) of the vehicle 1. The battery 20 is an example of a “battery” in the claims.

The battery sensor 22 is attached to the battery 20. The battery sensor 22 detects physical quantities such as a voltage, a current, and a temperature of the battery 20. The battery sensor 22 includes, for example, a voltage sensor, a current sensor, and a temperature sensor. The battery sensor 22 detects the voltage of the battery 20 using the voltage sensor, detects the current of the battery 20 using the current sensor, and detects the temperature of the battery 20 using the temperature sensor. The battery sensor 22 outputs information (hereinafter referred to as “battery information”) such as the voltage value, the current value, and the temperature of the battery 20 that have been detected to the control device 100.

The power conversion device 30 boosts or lowers a voltage of DC power supplied (discharged) from the battery 20 to a voltage when power is supplied to the traveling motor 10, further performs the conversion into power of an AC (AC power) for driving the traveling motor 10, and outputs the AC power to the traveling motor 10. The power conversion device 30 converts the AC power generated by the traveling motor 10 operating as a regenerative brake into DC power, further boosts or lowers a voltage to a voltage when the battery 20 is charged, outputs the DC power to the battery 20, and causes the battery 20 to store the DC power. That is, for example, the power conversion device 30 implements a function similar to that of a combination of a DC-DC converter and an AC-DC converter or a function similar to that of an inverter. The power conversion device 30 may include a function of converting the DC power supplied (discharged) from the battery 20 into AC power, for example, for operating household electric appliances at the time of an emergency or the like or for supplying power to a power system in an electric power selling process or the like, and allows the AC power to be output from an external connection device (not shown). The external connection device (not shown) is, for example, a power supply connector such as a Universal Serial Bus (USB) terminal or an accessory socket (a so-called cigar socket), a commercial power outlet for operating a household electric appliance or a personal computer, a connector for connecting to a power system at the time of electric power selling, or the like. At this time, the power conversion device 30 may boost or lower the power according to an output destination of the power output from the externally connected device (not shown) and then output the boosted or lowered power. Details regarding the configuration and operation of the power conversion device 30 will be described below.

The power sensor 38 is attached to power wiring on the traveling motor 10 side of the power conversion device 30. The power sensor 38 includes, for example, measurement instruments such as a wattmeter, a voltmeter, and an ammeter, and the power output from the power conversion device 30 to the traveling motor 10 is measured on the basis of the measured values of these measurement instruments (hereinafter referred to as “output power”). The power sensor 38 outputs information of the measured output power of the power conversion device 30 (hereinafter referred to as “output power information”) to the control device 100.

The driving operation elements 50 include, for example, an accelerator pedal, a brake pedal, a shift lever, a steering wheel, a variant steering wheel, a joystick, and other operation elements. The driving operation element 50 is equipped with a sensor that detects whether or not the user (the driver) of the vehicle 1 has performed an operation on each operation element or an amount of operation. The driving operation element 50 outputs a detection result of the sensor to the control device 100. For example, an accelerator opening degree sensor is attached to the accelerator pedal, detects an amount of operation on the accelerator pedal by the driver, and outputs the detected amount of operation as an accelerator opening degree to the control device 100. For example, a brake depression amount sensor is attached to the brake pedal, detects an amount of operation on the brake pedal by the driver, and outputs the detected amount of operation as the amount of brake depression to the control device 100. The accelerator opening degree is information for the driver who instructs (requests) the control device 100 to supply power from the battery 20 to the traveling motor 10 while the vehicle 1 is traveling. In other words, the accelerator opening degree is information indicating the amount of power that is supplied to the traveling motor 10 requested by the driver. The accelerator opening degree is information that can be a command value of the output power required for the traveling motor 10 generated by the control device 100 to be described below.

The vehicle sensor 60 detects the traveling state of the vehicle 1. The vehicle sensor 60 includes, for example, a vehicle speed sensor that detects the speed of the vehicle 1 or an acceleration sensor that detects the acceleration of the vehicle 1. The vehicle speed sensor detects a speed of the vehicle 1 and outputs information of the detected vehicle speed of the vehicle 1 to the control device 100. The vehicle speed sensor may include, for example, a speed calculator and wheel speed sensors attached to drive wheels 12 of the vehicle 1, and may derive (detect) the speed (the vehicle speed) of the vehicle 1 by integrating wheel speeds detected by the wheel speed sensors. The acceleration sensor detects the acceleration of the vehicle 1 and outputs information of the detected acceleration of the vehicle 1 to the control device 100. The vehicle sensor 60 may include, for example, a yaw rate sensor that detects an angular velocity around the vertical axis of the vehicle 1, a direction sensor that detects the direction of the vehicle 1, and the like. In this case, each sensor outputs the detected detection result to the control device 100.

The control device 100 controls an operation of the power conversion device 30 in accordance with a detection result output by each sensor provided in the driving operation element 50, i.e., an operation of the user (the driver) of the vehicle 1 on each operation element. In other words, the control device 100 controls the driving force of the traveling motor 10. The control device 100 may include, for example, separate control devices such as a motor control unit, a battery control unit, a power drive unit (PDU) control unit, and a voltage control unit (VCU) control unit. For example, the control device 100 may be replaced with a control device such as a motor electronic control unit (ECU), a battery ECU, a PDU-ECU, or a VCU-ECU.

The control device 100 controls the supply amount of AC power supplied from the battery 20 to the traveling motor 10 or a frequency (i.e., a voltage waveform) of the supplied AC power in accordance with the accelerator opening degree detected by the accelerator opening degree sensor when the vehicle 1 travels. Thus, the control device 100 generates a command value of the output power required for the power conversion device 30 such that the power from the battery 20 is supplied to the traveling motor 10. At this time, the control device 100 may change (adjust) the command value of the output power required for the power conversion device 30 in consideration of, for example, battery information output by the battery sensor 22, output power information output by the power sensor 38, and the like. Further, the control device 100 may change (adjust) the command value of the output power required for the power conversion device 30 in consideration of, for example, the gear ratio of the transmission mechanism that is controlled by the control device 100, the vehicle speed included in traveling state information output by the vehicle sensor 60, and the like. The command value of the output power generated by the control device 100 includes, for example, information such as the voltage value and the current value of AC power supplied from the battery 20 to the traveling motor 10 and a timing when DC power is supplied (discharged) from the battery 20. The control device 100 outputs the generated command value of the output power to the power conversion device 30. The command value of the output power generated by the control device 100 is an example of a “request command value of the output power for the load” in the claims.

The control device 100 operates, for example, when a hardware processor such as a central processing unit (CPU) executes a program (software). The control device 100 may be implemented by hardware (including a circuit unit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The control device 100 may be implemented by a dedicated LSI circuit. The program may be pre-stored in a storage device (a storage device including a non-transitory storage medium) such as a hard disk drive (HDD) or a flash memory provided in the vehicle 1 or may be stored in a removable storage medium (a non-transitory storage medium) such as a DVD or a CD-ROM and installed in the HDD or the flash memory provided in the vehicle 1 when the storage medium is mounted in a drive device provided in the vehicle 1.

### Configuration of Power Conversion Device

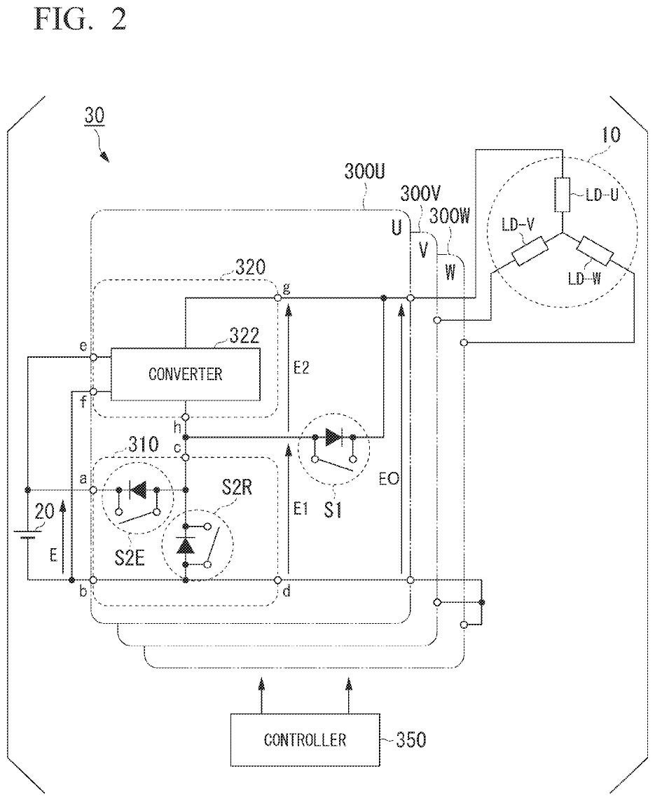

FIG. 2 is a diagram showing an example of a configuration of the power conversion device 30. In FIG. 2, the battery 20 and the traveling motor 10 related to the power conversion device 30 are also shown. The power conversion device 30 shown in FIG. 2 has a configuration corresponding to the traveling motor 10 which is a three-phase AC motor. Loads LD (loads LD-U, LD-V, and LD-W) provided in the traveling motor 10 are inductive loads of the phases in the traveling motor 10. The power conversion device 30 includes, for example, three power converters 300 (a power converter 300U, a power converter 300V, and a power converter 300W) and a controller 350.

Although the traveling motor 10 can be driven by AC power output by one power converter 300 when the traveling motor 10 is a single-phase AC motor, it is necessary to output AC power at phases (a U phase, a V phase, and a W phase) of three-phase AC when the traveling motor 10 is a three-phase AC motor as described above. Thus, the power conversion device 30 drives the traveling motor 10 with the AC power output by each of the three power converters 300 as shown in FIG. 2. The power converter 300U is a power converter 300 corresponding to the U phase of three-phase AC, the power converter 300V is a power converter 300 corresponding to the V phase of three-phase AC, and the power converter 300W is a power converter 300 corresponding to the W phase of the three-phase AC. The power converter 300U, the power converter 300V, and the power converter 300W may have the same configuration or may have a configuration in which some components are shared. The power converter 300U, the power converter 300V, and the power converter 300W output AC powers having the same voltage waveform. For example, the power conversion device 30 performs conversion into AC powers having different phases (having phases shifted by 120°) in the same voltage waveform, for example, by differentially synthesizing AC powers output by the power converters 300, and outputs the AC powers to the traveling motor 10. In the following description, for the sake of simplicity of description, the configuration and operation of the power converter 300U corresponding to the U phase of the three-phase AC will be described. Thus, in the following description, when the power converter 300U, the power converter 300V, and the power converter 300W are not distinguished from each other, they are simply referred to as a “power converter 300.”

The power converter 300 converts DC power supplied (discharged) from the battery 20 into AC power having a voltage waveform represented by a sinusoidal wave having a positive value and outputs the AC power at the corresponding phase of the traveling motor 10. The controller 350 controls the generation of the voltage waveform by each power converter 300 in accordance with a command value (hereinafter referred to as a “request command value”) of the output power output by the control device 100. At this time, the controller 350 generates a command value (hereinafter referred to as a “voltage command value”) of output power for allowing the power converter 300 to output the AC power on the basis of the request command value and the voltage value and the current value of the AC power output by the power converter 300. The controller 350 may allow a component provided in the power converter 300 to control an operation by inputting or setting the generated voltage command value as an output waveform profile to or in the power converter 300 or may directly control the operation of the component provided in the power converter 300 on the basis of the generated voltage command value. Thereby, in the vehicle 1, the AC powers output at the phases by the power converters 300 provided in the power conversion device 30 are differentially synthesized and AC power of a voltage waveform represented by a sinusoidal wave having positive and negative values is supplied between the phases of the traveling motor 10. More specifically, AC powers of voltage waveforms represented by sinusoidal waves having positive values output by the two power converters 300 corresponding to two phases among three phases of the traveling motor 10 are differentially synthesized and AC power of a voltage waveform represented by a sinusoidal wave having positive and negative values using an inter-terminal voltage=0 [V] as a reference voltage is supplied between the phases of the traveling motor 10. For example, AC power of a voltage value of “U-V” of sinusoidal waves having positive and negative values using an inter-terminal voltage=0 [V] between the U and V phases as a reference voltage output from the power converter 300U and the power converter 300V is supplied between the U phase and the V phase of the traveling motor 10. Likewise, AC power of a voltage value of “V-W” or AC power of a voltage value of “W-U” is supplied between the V phase and the W phase of the traveling motor 10 or between the W phase and the U phase thereof. The power converter 300 is an example of a “power converter” in the claims and the controller 350 is an example of a “controller” in the claims. The AC power output by the power converter 300 is an example of “third output power” in the claims and a voltage waveform represented by a sinusoidal wave having a positive value in the AC power output by the power converter 300 is an example of a “control waveform” in the claims.

The controller 350 operates, for example, when a hardware processor such as a central processing unit (CPU) executes a program (software). The controller 350 may be implemented by hardware (including a circuit unit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The controller 350 may be implemented by a dedicated LSI circuit. Like the program associated with the control device 100, the program may be pre-stored in a storage device (a storage device including a non-transitory storage medium) such as a hard disk drive (HDD) or a flash memory provided in the vehicle 1 or may be stored in a removable storage medium (a non-transitory storage medium) such as a DVD or a CD-ROM and installed in the HDD or the flash memory provided in the vehicle 1 when the storage medium is mounted in a drive device provided in the vehicle 1. Details regarding the configuration and operation of the controller 350 will be described below.

The power converter 300 includes, for example, a rectangular voltage generator 310, a voltage waveform generator 320, and a switching element S1. The rectangular voltage generator 310 includes, for example, a switching element S2E and a switching element S2R. The voltage waveform generator 320 includes, for example, a converter 322.

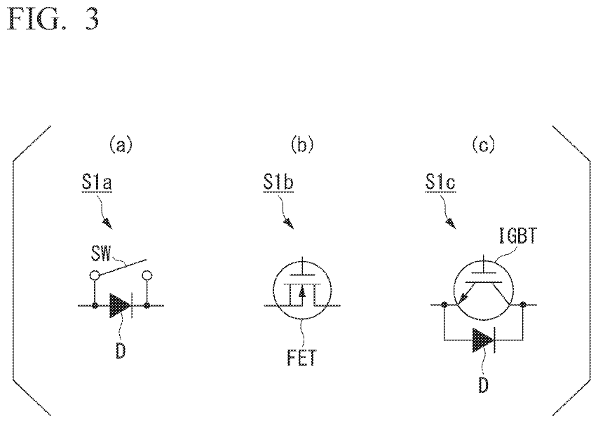

FIG. 2 shows an example in which the switching element S1, the switching element S2E, and the switching element S2R are composed of a diode and a switch. In the power converter 300, the configurations of the switching element S1, the switching element S2E, and the switching element S2R are not limited to the configurations shown in FIG. 2. FIG. 3 is a diagram showing an example of the configuration of the switching element Si provided in the power conversion device 30. A switching element S1a shown in (a) of FIG. 3 has a configuration of a diode D and a switch SW shown in FIG. 2. A switching element S1b shown in (b) of FIG. 3 is an example of a case where the switching element S1b is composed of a field effect transistor (FET). The switching element S1c shown in (c) of FIG. 3 is an example in which a diode D and an insulated gate bipolar transistor (IGBT) are configured. A process of controlling the conductive state and the non-conductive state of the switch SW provided in the switching element S1a shown in (a) of FIG. 3 and a process of controlling the ON state and the OFF state of the field effect transistor FET provided in the switching element S1b shown in (b) of FIG. 3 and the insulated gate bipolar transistor IGBT provided in the switching element S1c shown in (c) of FIG. 3 are performed by the controller 350. In the following description, a process in which the switch SW is controlled such that it is in the conductive state or the non-conductive state (the field effect transistor FET or the insulated gate bipolar transistor IGBT may be controlled such that it is in the ON state or the OFF state) is referred to as a process in which each switching element (the switching element S1, the switching element S2E, and the switching element S2R) is controlled such that it is in the conductive state or the non-conductive state.

The rectangular voltage generator 310 is a converter for converting the DC power supplied (discharged) from the battery 20 into output power (in other words, a rectangular pulse) of a rectangular voltage waveform in accordance with a control process of the controller 350 and outputting the output power. In the rectangular voltage generator 310, a half-bridge type converter includes the switching element S2E and the switching element S2R. The rectangular voltage generator 310 generates a rectangular pulse having a magnitude of a DC voltage E supplied between a first end a and a second end b by the battery 20 and outputs the generated rectangular pulse as the output voltage E1 between a third end c and a fourth end d.

The switching element S2E is connected between the first end a and the third end c and switches the output of the DC voltage E supplied from the battery 20 side (the first end a side) to the traveling motor 10 side, i.e., the load LD side (the third end c side), in accordance with a process of controlling the conductive state and the non-conductive state in the controller 350. The switching element S2E outputs a rectangular pulse having a pulse width corresponding to a timing when the state is switched between the conductive state and the non-conductive state by the controller 350. The controller 350 changes a pulse width of the rectangular pulse generated by the rectangular voltage generator 310 by changing a timing when the switching element S2E is controlled such that it is in the conductive state or the non-conductive state.

The switching element S2R is connected between the third end c and the fourth end d and switches the output of the voltage of the rectangular pulse generated by the rectangular voltage generator 310 to the voltage waveform generator 320 side (the third end c side) in accordance with a process of controlling the conductive state and the non-conductive state in the controller 350. In other words, the switching element S2R switches the connection between the rectangular voltage generator 310 and the voltage waveform generator 320. The controller 350 allows the state to be switched to a state in which the rectangular voltage generator 310 and the voltage waveform generator 320 are not connected by controlling the switching element S2R such that it is in the conductive state and the rectangular pulse generated by the rectangular voltage generator 310 is prevented from being output to the voltage waveform generator 320 side. Thereby, in the power converter 300, only the output voltage from the voltage waveform generator 320 is output to the load LD side (i.e., the traveling motor 10). On the other hand, the controller 350 allows the state to be switched to a state in which the rectangular voltage generator 310 and the voltage waveform generator 320 are connected (series connection) by controlling the switching element S2R such that it is in the non-conductive state and allows the rectangular pulse generated by the rectangular voltage generator 310 to be output to the voltage waveform generator 320 side. Thereby, in the power converter 300, an output voltage obtained by combining the output voltage E1 from the rectangular voltage generator 310 and the output voltage from the voltage waveform generator 320 is output to the load LD side.

The rectangular voltage generator 310 is an example of a “second converter” in the claims. The third end c is an example of an “another end of the second terminal pair” in the claims and the fourth end d is an example of a “one end of the second terminal pair” in the claims. The output voltage E1 is an example of “second output power” in the claims and the voltage waveform of the output voltage E1 is an example of a “second voltage waveform” in the claims. The switching element S2E is an example of a “second switching element” in the claims and the switching element S2R is an example of a “third switching element” in the claims.

The voltage waveform generator 320 converts DC power supplied (discharged) from the battery 20 into output power of the voltage waveform based on the output waveform profile input or set by the controller 350 and outputs the output power. The voltage waveform generator 320 outputs the output voltage E2, which is obtained by converting the DC voltage E supplied between the first end e and the second end f by the battery 20 on the basis of the output waveform profile, between a third end g and a fourth end h.

The converter 322 outputs an output voltage of a voltage waveform based on the input or set output waveform profile. The output waveform profile is a voltage command value generated by the controller 350 and is sequentially input or set by the controller 350. For example, the output waveform profile may be sequentially input or set by the control device 100. The configuration of the converter 322 will be described below.

The voltage waveform generator 320 (which may be the converter 322) is an example of a “first converter” in the claims. The third end g is an example of a “one end of the first terminal pair” in the claims and the fourth end h is an example of an “another end of the first terminal pair” in the claims. The output voltage E2 is an example of “first output power” in the claims and the voltage waveform of the output voltage E2 is an example of a “first voltage waveform” in the claims.

The switching element S1 is connected between the third end c of the rectangular voltage generator 310 and the fourth end h of the voltage waveform generator 320 and the third end g of the voltage waveform generator 320 and limits a direction in which the output voltage output from the power converter 300 is supplied in accordance with a process of controlling the conductive state and the non-conductive state in the controller 350. Thereby, the switching element S1 switches a direction of the voltage supplied between the power converter 300 and the traveling motor 10. When the switching element S1 is controlled by the controller 350 such that it is in the non-conductive state, the output voltage output from the power converter 300 is allowed to be supplied to the load LD side (i.e., the traveling motor 10) and the voltage output from the load LD side is prevented from being supplied to the power converter 300 side. On the other hand, when the switching element S1 is controlled by the controller 350 such that it is in the conductive state, the voltage output from the load LD side is allowed to be supplied to the power converter 300 side. When the traveling motor 10 for traveling of the vehicle 1 is driven, the controller 350 controls the switching element S1 such that it is in the non-conductive state. When the battery 20 is charged with electric power generated by the traveling motor 10 operating as the regenerative brake, the switching element S1 is controlled such that it is in the conductive state. The switching element S1 is an example of a “first switching element” in the claims.

According to such a configuration, in the power conversion device 30, the controller 350 controls each power converter 300. The power converter 300 outputs the AC voltage EO obtained by converting the DC voltage E supplied (discharged) from the battery 20 between the fourth end d and the third end g that are output terminals of the power converter 300 in accordance with the control process of the controller 350. That is, the power converter 300 supplies the load LD side (i.e., the traveling motor 10) with the output voltage E2 after the conversion process of the voltage waveform generator 320 or the output voltage obtained by combining the output voltage E2 after the conversion process of the voltage waveform generator 320 and the output voltage E1 after the conversion process of the rectangular voltage generator 310 as the AC voltage EQ. When the AC voltage EO obtained by combining the output voltage E1 and the output voltage E2 is output, the power conversion device 30 can generate an AC amplitude having a voltage value that is at most twice the DC voltage E of the battery 20. Here, in the power conversion device 30, as shown in FIG. 2, fourth ends d that are output terminals of the power converter 300U, the power converter 300V, and the power converter 300W are connected to each other. Thus, AC voltages EO output by any two power converters 300 among the power converter 300U, the power converter 300V, and the power converter 300W are differentially synthesized and a differential synthesis result is output to the traveling motor 10 between the phases.

### Voltage Waveform Generated by Power Conversion Device

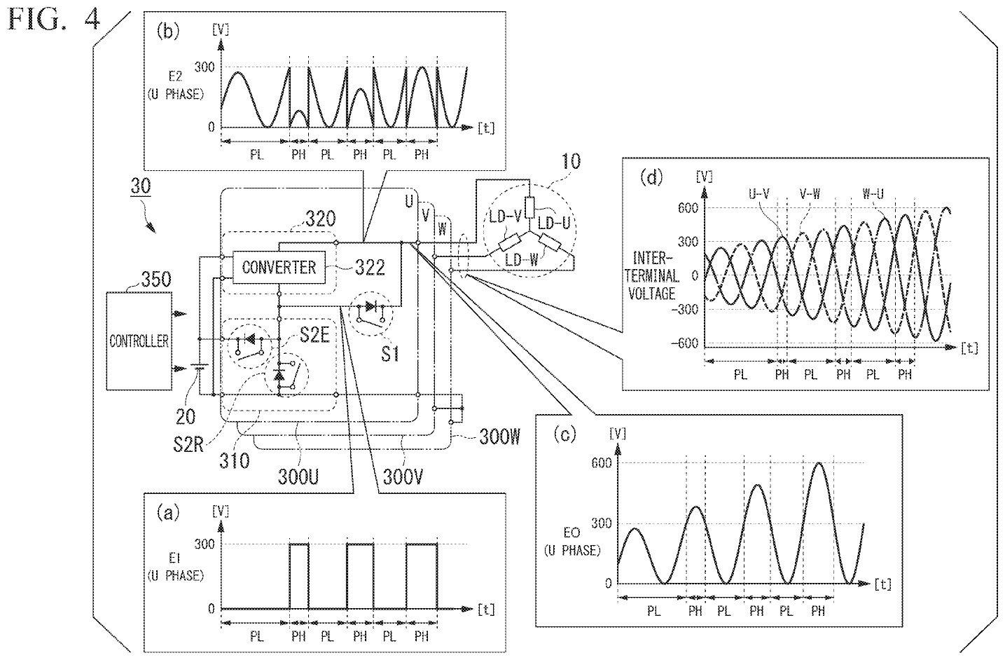

FIG. 4 is a diagram showing an example of a voltage waveform generated by the power conversion device 30. In FIG. 4, an example of the voltage waveform of the output voltage generated at each location is shown in the configuration diagram of the power conversion device 30 shown in FIG. 2.

In the power conversion device 30, the controller 350 controls the switching element S2E and the switching element S2R of the rectangular voltage generator 310 provided in each power converter 300 on the basis of the generated voltage command value or an output waveform profile indicating the voltage command value, such that the output voltage E1 of the rectangular voltage waveform (the rectangular pulse) as shown in (a) of FIG. 4 is generated and output. The voltage waveform of the output voltage E1 shown in (a) of FIG. 4 is an example of a case where the rectangular voltage generator 310 provided in the power converter 300U generates and outputs the voltage. More specifically, the controller 350 generates a voltage command value of a rectangular pulse having 0 [V] during a low-level period PL in which an AC voltage EO having a voltage value exceeding a voltage value (hereinafter referred to as a “DC voltage value”) of the DC voltage E of the battery 20 is not output and having a DC voltage value during a high-level period PH in which an AC voltage EO having a voltage value exceeding the DC voltage value is output on the basis of the voltage waveform (see (c) of FIG. 4) of the AC voltage EO that is represented by a sinusoidal wave having a positive value output by the power conversion device 30. The controller 350 controls the switching element S2E and the switching element S2R of the rectangular voltage generator 310 provided in the power converter 300U on the basis of the generated voltage command value. Thereby, in the rectangular voltage generator 310, as shown in (a) of FIG. 4, the output voltage E1 of the rectangular pulse in which the low-level voltage value is 0 [V] and the high-level voltage value is the DC voltage value of the battery 20 (300 [V] in (a) of FIG. 4) is generated and output.

In the power conversion device 30, the controller 350 allows the output voltage E2 of the voltage waveform as shown in (b) of FIG. 4 to be generated and output by inputting or setting the generated voltage command value as an output waveform profile to or in the voltage waveform generator 320 provided in each power converter 300. The voltage waveform of the output voltage E2 shown in (b) of FIG. 4 is an example of a case where the voltage waveform generator 320 provided in the power converter 300U generates and outputs the voltage waveform. The output waveform profile input or set by the controller 350 is a profile for generating the output voltage E2 of a voltage waveform obtained by subtracting the voltage waveform (the rectangular pulse) of the output voltage E1 output by the rectangular voltage generator 310 from the voltage waveform (see (c) of FIG. 4) of the AC voltage EO that is represented by a sinusoidal wave having a positive value output by the power conversion device 30. More specifically, the output waveform profile is a profile of a voltage command value in which the voltage value of the output voltage E2 is set to the voltage value of the AC voltage EO (hereinafter referred to as “AC voltage value”) during the low-level period PL in which the output voltage E1 has the low level and the voltage value of the output voltage E2 is set to “AC voltage value−DC voltage value” during the high-level period PH in which the output voltage E1 has the high level. Thereby, the voltage waveform generator 320 generates and outputs the output voltage E2 of a voltage waveform in which the voltage value of the output voltage E2 is reduced by the voltage value of the output voltage E1 during the high-level period PH as shown in (b) of FIG. 4.

In this way, in the power conversion device 30, the controller 350 allows the rectangular voltage generator 310 to output the output voltage E1 and allows the voltage waveform generator 320 to output the output voltage E2. In the power conversion device 30, the output voltage E1 output by the rectangular voltage generator 310 and the output voltage E2 output by the voltage waveform generator 320 are combined on the load LD side of the switching element S1 provided in each power converter 300. At this time, in the power conversion device 30, the controller 350 allows the rectangular voltage generator 310 to output the output voltage E1 according to a timing when the voltage waveform generator 320 outputs the output voltage E2. More specifically, at a timing when the controller 350 changes the period from the low-level period PL to the high-level period PH or vice versa, the conductive state and the non-conductive state of each of the switching element S1, the switching element S2E, and the switching element S2R provided in the power converter 300 are controlled. Thereby, in the power conversion device 30, an AC voltage EO in which the voltage waveform of the output voltage E1 and the voltage waveform of the output voltage E2 are waveform-synthesized is output from each power converter 300. Thereby, as shown in (c) of FIG. 4, an AC voltage EO of a voltage waveform represented by a sinusoidal wave having a positive value less than or equal to a voltage value (600 [V] in (c) of FIG. 4) that is at most twice the DC voltage value when the battery 20 is discharged is supplied to the load LD side (i.e., the traveling motor 10). The voltage waveform of the AC voltage EO shown in (c) of FIG. 4 is an example of the voltage waveform of the AC voltage EO output by the power converter 300U.

AC voltages EO output at phases by the power converters 300 provided in the power conversion device 30 are differentially synthesized and an AC voltage of a voltage waveform represented by a sinusoidal wave having positive and negative values using an inter-terminal voltage=0 [V] as a reference voltage as shown in (d) of FIG. 4 is supplied to the traveling motor 10 between the phases. The inter-terminal voltage U-V shown in (d) of FIG. 4 is a voltage value of an AC voltage that is supplied between the U phase and the V phase of the traveling motor 10 when AC voltages EO output by the power converter 300U and the power converter 300V are differentially synthesized. The inter-terminal voltage V-W shown in (d) of FIG. 4 is a voltage value of an AC voltage that is supplied between the V phase and the W phase of the traveling motor 10 when AC voltages EO output by the power converter 300V and the power converter 300W are differentially synthesized. The inter-terminal voltage W-U shown in (d) of FIG. 4 is a voltage value of an AC voltage that is supplied between the W phase and the U phase of the traveling motor 10 when AC voltages EO output by the power converter 300W and the power converter 300U are differentially synthesized. Thereby, the traveling motor 10 is driven (rotated) by an AC voltage of a sinusoidal wave supplied between the phases.

### Operation of Power Conversion Device

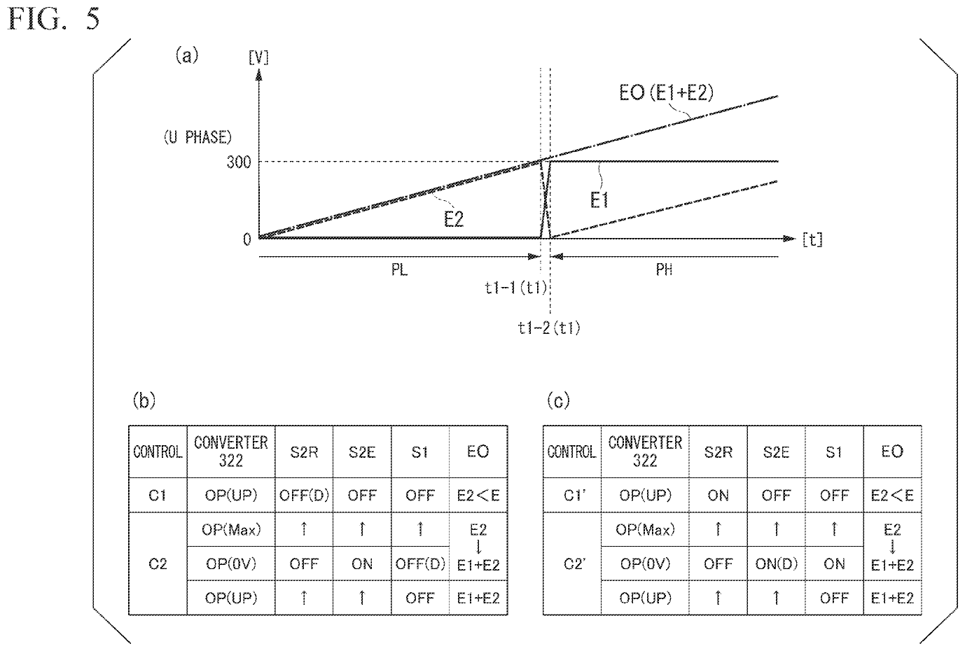

Here, a control process of the controller 350 performed when the voltage waveform of the output voltage E1 and the voltage waveform of the output voltage E2 are waveform-synthesized in the power conversion device 30 will be described. FIG. 5 is a diagram showing an example of a detailed timing when the controller 350 provided in the power conversion device 30 controls the power converter 300 and a control process. In (a) of FIG. 5, an example of a state of a change in a voltage waveform of the output voltage E1, the output voltage E2, and the AC voltage EO at a timing (see, for example, (c) of FIG. 4) of transition from the low-level period PL to the high-level period PH is shown. In (b) of FIG. 5 and (c) of FIG. 5, a state of each switching element controlled by the controller 350 is shown. (b) of FIG. 5 is an example in which the traveling motor 10 for traveling of the vehicle 1 is driven and (c) of FIG. 5 is an example in which the battery 20 is charged with the electric power generated by the traveling motor 10 operating as a regenerative brake. In (b) of FIG. 5 and (c) of FIG. 5, “OP” indicates that the converter 322 is allowed to output the output voltage E2 when an output waveform profile is input or set to or in the voltage waveform generator 320. In the description in “(): parentheses” in “OP,” “UP” indicates a state (including an intermediate state) in which the voltage value of the output voltage E2 output by the converter 322 is changed such that it is increased, “Max” indicates a state in which the voltage value of the output voltage E2 output by the converter 322 becomes a maximum value, and “0 V” indicates a state in which the voltage value of the output voltage E2 output by the converter 322 becomes 0 [V]. In (b) of FIG. 5 and (c) of FIG. 5, “ON” indicates that the switching element is controlled such that it is in the conductive state, “OFF” indicates that the switching element is controlled such that it is in the non-conductive state, “↑: Up arrow” indicates that the control of the switching element has not been changed, and the description in “(): parentheses” indicates a component flowing through the switching element.

First, a control process of the controller 350 when the traveling motor 10 for traveling of the vehicle 1 shown in (b) of FIG. 5 is driven will be described with reference to (a) of FIG. 5. During the low-level period PL shown in (a) of FIG. 5, i.e., at the time of a state in which an AC voltage value of the AC voltage EO (which may be the voltage value of the output voltage E2) is smaller than a DC voltage value of the DC voltage E supplied from the battery 20, the controller 350 performs a control process such that each of the switching element S2E, the switching element S2R, and the switching element S1 is in the non-conductive state as in the field of control C1 shown in (b) of FIG. 5. Thereby, the power converter 300 outputs the output voltage E2 output by the converter 322 as the AC voltage EO during a period that is the low-level period PL. In the power converter 300, the voltage value of the output voltage E2 (i.e., the AC voltage value of the AC voltage EO) increases on the basis of the output waveform profile input or set by the controller 350 to or in the voltage waveform generator 320. At this time, the output voltage E1 output by the rectangular voltage generator 310 is also output through the diode D provided in the switching element S1, but the output voltage E1 does not affect the AC voltage value of the AC voltage EO because the output voltage E1 is 0 [V].

Subsequently, the controller 350 controls each of the switching element S2E, the switching element S2R, and the switching element S1 as in the field of control C2 shown in (b) of FIG. 5 at a timing of time t1 of transition from the low-level period PL to the high-level period PH shown in (a) of FIG. 5. That is, the controller 350 allows the rectangular voltage generator 310 to output the output voltage E1 of a rectangular voltage waveform (a rectangular pulse). Thereby, in the power converter 300, the output voltage E1 of the rectangular voltage waveform (the rectangular pulse) output by the rectangular voltage generator 310 is output through the diode D provided in the switching element S1 and the AC voltage EO in which the voltage waveform of the output voltage E1 and the voltage waveform of the output voltage E2 are waveform-synthesized is output.

More specifically, when the AC voltage value of the AC voltage EO has increased to a voltage value equal to the DC voltage value of the DC voltage E, i.e., at a timing of time t1-1 when the voltage value of the output voltage E2 output by the converter 322 has become a maximum value (300 [V] in (a) of FIG. 5), the controller 350 controls the switching element S2E such that it is in a conductive state. Thereby, the output of the output voltage E1 based on the DC voltage E from the rectangular voltage generator 310 is started and the voltage value of the output voltage E1 becomes a DC voltage value of the DC voltage E supplied from the battery 20 between time t1-1 and time t1-2. In the power converter 300, the voltage waveform of the output voltage E1 and the voltage waveform of the output voltage E2 are waveform-synthesized and the supply of the AC voltage EO obtained by combining the output voltage E1 and the output voltage E2 to the load LD side (i.e., the traveling motor 10) is started from a timing of time t1-2 when the voltage value of the output voltage E2 output by the voltage waveform generator 320 becomes 0 [V] on the basis of the output waveform profile.

During the high-level period PH shown in (a) of FIG. 5, the AC voltage value of the AC voltage EO obtained by combining the output voltage E1 and the output voltage E2 is further increased as the voltage value of the output voltage E2 output by the voltage waveform generator 320 on the basis of the output waveform profile increases.

In this way, in the power conversion device 30, the voltage waveform of the output voltage E2 and the voltage waveform of the output voltage E1 are waveform-synthesized in each power converter 300 in accordance with the control process of the controller 350. Thereby, in the power conversion device 30, the AC voltage value of the AC voltage EO output by each power converter 300 is increased to a voltage value that is at most twice the DC voltage E of the battery 20 (at most 600 [V] in (a) of FIG. 5).

When the battery 20 is charged with the electric power generated by the traveling motor 10 operating as the regenerative brake, the controller 350 controls each switching element such that the AC voltage EO output by the traveling motor 10 is supplied to the battery 20 side in contrast to a case where the AC voltage EO is supplied to the traveling motor 10 described above. It is only necessary for the operation of the controller 350 in this case to be equivalent to a reverse operation associated with the operation of driving the traveling motor 10 for traveling of the vehicle 1 described above. In contrast to control C1 and control C2 shown in (b) of FIG. 5, control C1′ and control C2′ shown in (c) of FIG. 5 are a process of controlling a switching element when electric power (for example, AC power equivalent to the AC voltage EO) output by the traveling motor 10 is supplied to the battery 20 side. Here, in control C2′ shown in (c) of FIG. 5, “ON(D)” indicates that electric power generated by the traveling motor 10 is supplied to the battery 20 side through the diode D provided in the switching element S2E even if the switching element S2E is not in the conductive state, but the switch SW provided in the switching element S2E is actively in the conductive state. This is more effective control because, for example, when the switching element S2E is composed of the field effect transistor FET (see (b) of FIG. 3), electric power can be supplied to the battery 20 side via a diode element provided in the field effect transistor FET, but it is possible to supply electric power to the battery 20 side more efficiently by actively setting the field effect transistor FET in the ON state and lowering an ON voltage. The other control process of the controller 350 shown in (c) of FIG. 5 is similar to the control process of the controller 350 shown in (b) of FIG. 5 described with reference to (a) of FIG. 5. Accordingly, a detailed description of a control process of the controller 350 when the battery 20 is charged with electric power generated by the traveling motor 10 operating as the regenerative brake will be omitted.

### Configuration of Converter

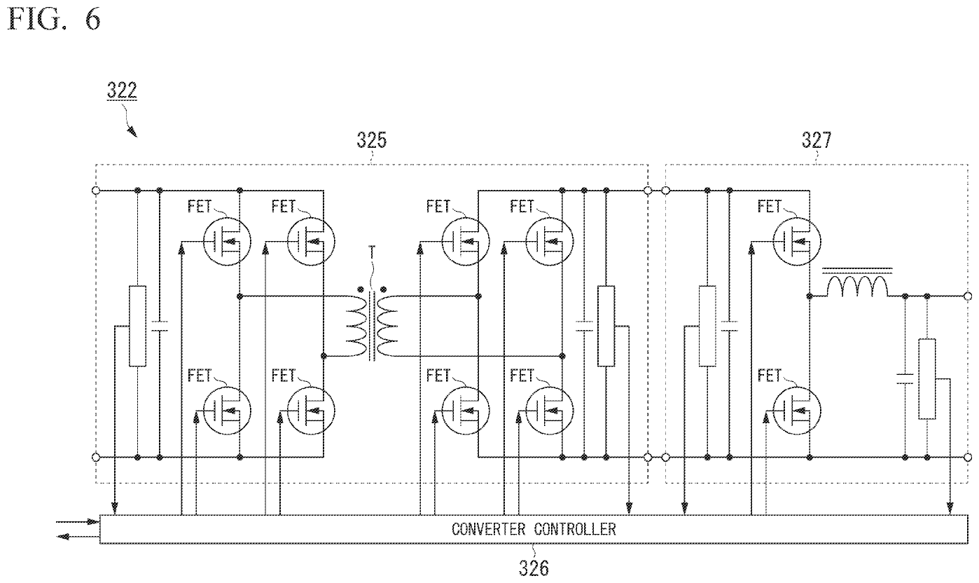

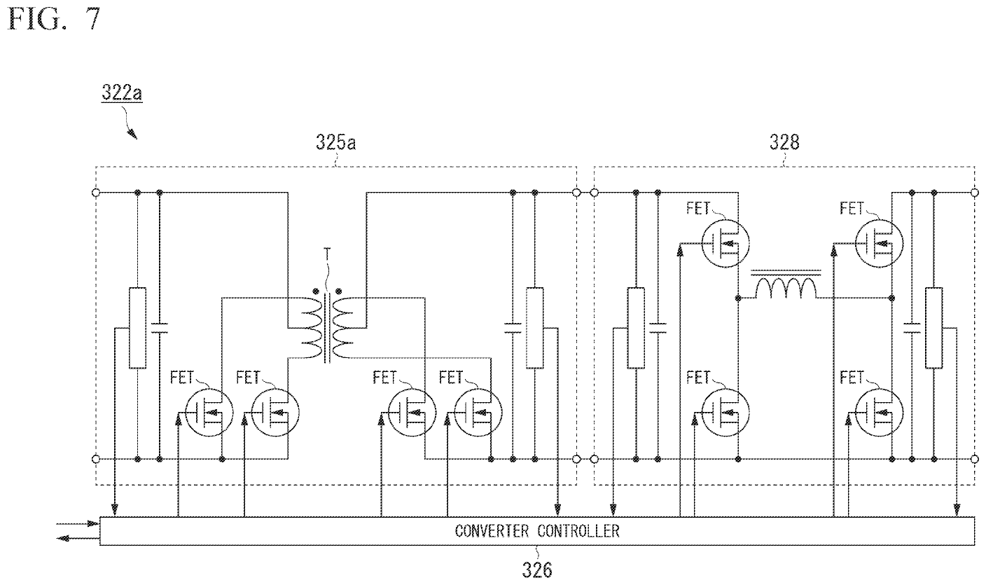

FIGS. 6 and 7 are diagrams showing an example of a configuration of the converter 322 within the voltage waveform generator 320 provided in the power conversion device 30. The converter 322 shown in FIG. 6 includes, for example, a DC-DC converter 325 and a converter controller 326. In FIG. 6, a configuration in which a buck-boost chopper 327 is connected to the DC-DC converter 325 is shown. The converter 322 (hereinafter referred to as a “converter 322a”) having another configuration shown in FIG. 7 includes, for example, a DC-DC converter 325a and the converter controller 326. In FIG. 7, a configuration in which a buck-boost converter 328 is connected to the DC-DC converter 325a is shown.

The DC-DC converter 325 is a bridge-type bidirectional isolated DC-DC converter in which a transformer T is connected between a primary-side full bridge circuit and a secondary-side full bridge circuit each having a configuration in which four field effect transistors FET are bridge-connected. The DC-DC converter 325a is a push-pull type bidirectional isolated DC-DC converter in which a transformer T is connected between a primary-side circuit and a secondary-side circuit each having a configuration in which two field effect transistors FET are connected in series. Because the configurations and the operations of the DC-DC converter 325 and the DC-DC converter 325a are equivalent to the configuration and the operation of the existing bidirectional isolated DC-DC converter, a detailed description thereof will be omitted.

Each of the buck-boost chopper 327 and the buck-boost converter 328 is an example of a configuration for boosting or lowering electric power generated by the traveling motor 10 to a voltage with which the battery 20 is charged when the traveling motor 10 has operated as the regenerative brake. In the converter 322 shown in FIG. 6, instead of the buck-boost chopper 327, the buck-boost converter 328 may be connected to the DC-DC converter 325. In the converter 322a shown in FIG. 7, the buck-boost chopper 327 may be connected to the DC-DC converter 325a instead of the buck-boost converter 328. The configuration for boosting or lowering a voltage of the power generated by the traveling motor 10 to the voltage with which the battery 20 is charged is not limited to the buck-boost chopper 327 and the buck-boost converter 328. Because the configurations and the operations of the buck-boost chopper 327 and the buck-boost converter 328 are equivalent to the configuration and operation of the existing buck-boost circuit, a detailed description thereof will be omitted.

The converter controller 326 controls the ON state and the OFF state of the respective field effect transistors FET provided in the DC-DC converter 325 and the DC-DC converter 325a in accordance with the output waveform profile input or set by the controller 350. Further, the converter controller 326 controls the ON state and the OFF state of the field effect transistors FET provided in the buck-boost chopper 327 and the buck-boost converter 328 in accordance with the output waveform profile input or set by the controller 350. The converter controller 326 generates a gate drive signal for driving the gate of each field effect transistor FET. Although a configuration in which the converter controller 326 controls the field effect transistors FET provided in the buck-boost chopper 327 and the buck-boost converter 328 is shown in FIGS. 6 and 7, the field effect transistors FET provided in the buck-boost chopper 327 and the buck-boost converter 328 may be controlled by another controller (not shown) that operates in conjunction with the converter controller 326.

### Configuration of Converter Controller

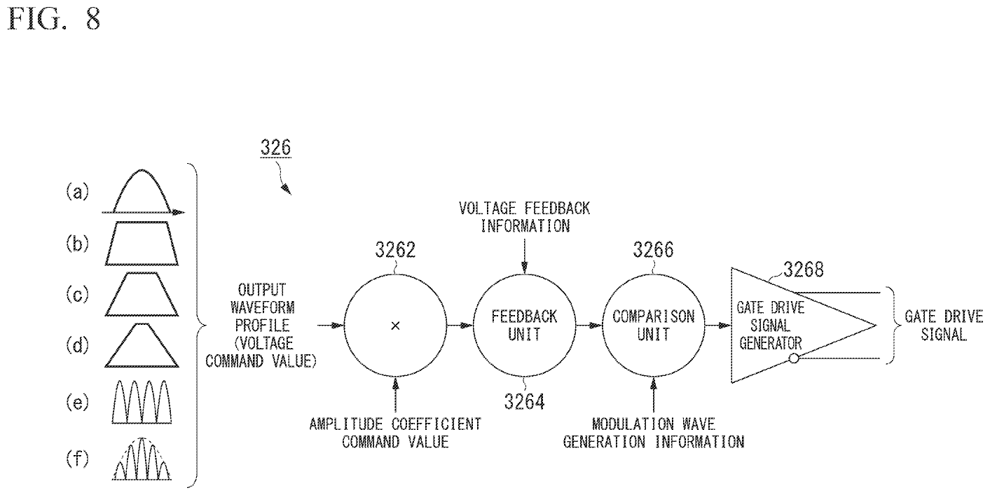

FIG. 8 is a diagram showing an example of a functional configuration of the converter controller 326 provided in the converter 322. In FIG. 8, a configuration related to the control function of the DC-DC converter 325 in the converter controller 326 is shown. The converter controller 326 includes, for example, a multiplier 3262, a feedback unit 3264, a comparison unit 3266, and a gate drive signal generator 3268.

The multiplier 3262 obtains a voltage value to be output from the DC-DC converter 325 by multiplying a voltage command value indicated in the output waveform profile input or set by the controller 350 by an amplitude coefficient command value input by the controller 350. In FIG. 8, (a) to (f) show examples of the output waveform profile. The multiplier 3262 obtains a voltage value to be output from the DC-DC converter 325 by multiplying a voltage command value indicated in the output waveform profile by an amplitude coefficient command value for each sampling timing such that the voltage waveform corresponding to the output waveform profile as shown in (a) to (f) of FIGS. 8 is provided. The amplitude coefficient command value is a target value of the output voltage to be output to the converter 322. The amplitude coefficient command value is, for example, a request command value output by the control device 100. The amplitude coefficient command value may be included in the output waveform profile or the controller 350 may output the request command value output by the control device 100 separately from the output waveform profile.

The feedback unit 3264 performs feedback control on the basis of voltage feedback information input by the controller 350. The feedback unit 3264 generates a voltage control pulse for approximating the present voltage value output from the DC-DC converter 325 to the voltage value obtained by the multiplier 3262 in the feedback control. The feedback control in the feedback unit 3264 is, for example, PID control in which proportional (P), integral (I), and differential (D) control is combined. The feedback control in the feedback unit 3264 is not limited to the PID control and may be another feedback control method.

The comparison unit 3266 modulates the voltage control pulse generated by the feedback unit 3264 in a modulation algorithm corresponding to the modulation wave generation information input by the controller 350. The comparison unit 3266 modulates the voltage control pulse in a modulation algorithm such as pulse width modulation (PWM), pulse density modulation (PDM), or Δ-Σ modulation. The modulation wave generation information is information for designating these modulation algorithms The comparison unit 3266 outputs a modulated signal obtained by modulating the voltage control pulse.

The gate drive signal generator 3268 generates a gate drive signal to be input to a gate terminal of each field effect transistor FET provided in the DC-DC converter 325 on the basis of the modulated signal modulated by the comparison unit 3266. Thereby, each field effect transistor FET provided in the converter 322 is turned on or off in accordance with the input gate drive signal and the output voltage of the voltage waveform (see (b) of FIG. 4) corresponding to the output waveform profile input or set by the controller 350 is output from the DC-DC converter 325.

### Configuration of Controller

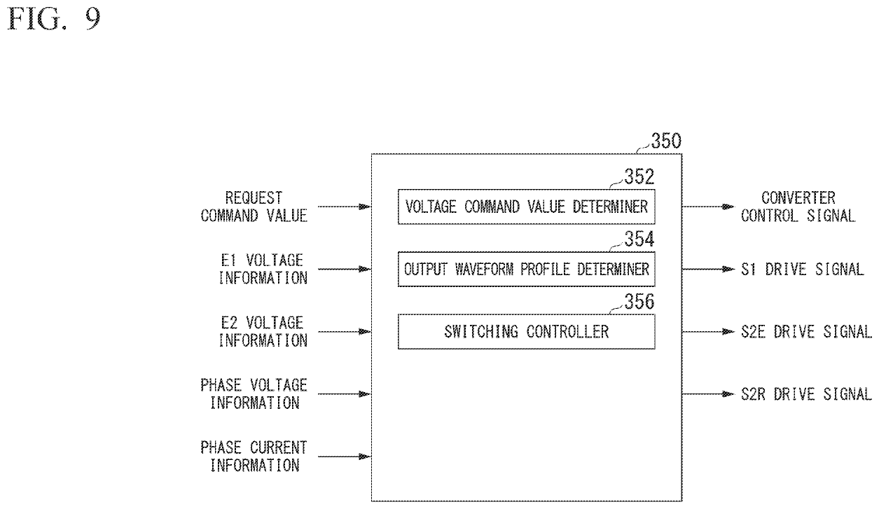

FIG. 9 is a diagram showing an example of a configuration of the controller 350 provided in the power conversion device 30. The controller 350 includes, for example, a voltage command value determiner 352, an output waveform profile determiner 354, and a switching controller 356.

The voltage command value determiner 352 decides on a voltage command value of an AC voltage EO to be subsequently output to each power converter 300 on the basis of a request command value output by the control device 100, voltage information of the output voltage E1 and voltage information of the output voltage E2 output by the power converters 300, and voltage information (phase voltage information) and current information (phase current information) of the AC voltage EO output by each power converter 300. At this time, the voltage command value determiner 352 decides on a voltage command value such that each power converter 300 outputs a modulated (phase-modulated) AC voltage EO in which a phase is different (a phase is shifted by 120°) in the same voltage waveform in consideration of differential synthesis of AC voltages EO supplied at phases of the traveling motor 10. The voltage information, the phase voltage information, and the phase current information used by the voltage command value determiner 352 to decide on the voltage command value of the AC voltage EO may be acquired from a voltage value and a current value detected by the voltage sensor and the current sensor installed at prescribed positions in each power converter 300 and/or the traveling motor 10 or may be, for example, a voltage value and a current value included in battery information output by the battery sensor 22, the output power information output by the power sensor 38, and the like.

The output waveform profile determiner 354 decides on the output waveform profile to be set in the converter 322 on the basis of the voltage command value decided on by the voltage command value determiner 352. At this time, the output waveform profile determiner 354 decides on the output waveform profile for each voltage command value for outputting AC voltages EO having different phases decided on by the voltage command value determiner 352, i.e., for each power converter 300. The output waveform profile determiner 354 inputs or sets the decided output waveform profile to or in the voltage waveform generator 320. That is, the output waveform profile determiner 354 outputs the output waveform profile to the converter controller 326 provided in the converter 322 and sets the output waveform profile in the converter controller 326. In FIG. 9, output waveform profile information set by the output waveform profile determiner 354 in the converter controller 326 is shown as a converter control signal.

The switching controller 356 controls the switching elements provided in the power converter 300 and the rectangular voltage generator 310 on the basis of the voltage command value decided on by the voltage command value determiner 352. That is, the switching controller 356 outputs a drive signal for controlling the conductive state and the non-conductive state to each of the switching element S1, the switching element S2E, and the switching element S2R. At this time, the switching controller 356 controls one switching element for each voltage command value for outputting an AC voltage EO having a different phase decided on by the voltage command value determiner 352, i.e., for each power converter 300. In FIG. 9, each of an S1 drive signal output to the switching element S1 by the switching controller 356, an S2E drive signal output to the switching element S2E, and an S2R drive signal output to the switching element S2R is shown.

### Process of Controller

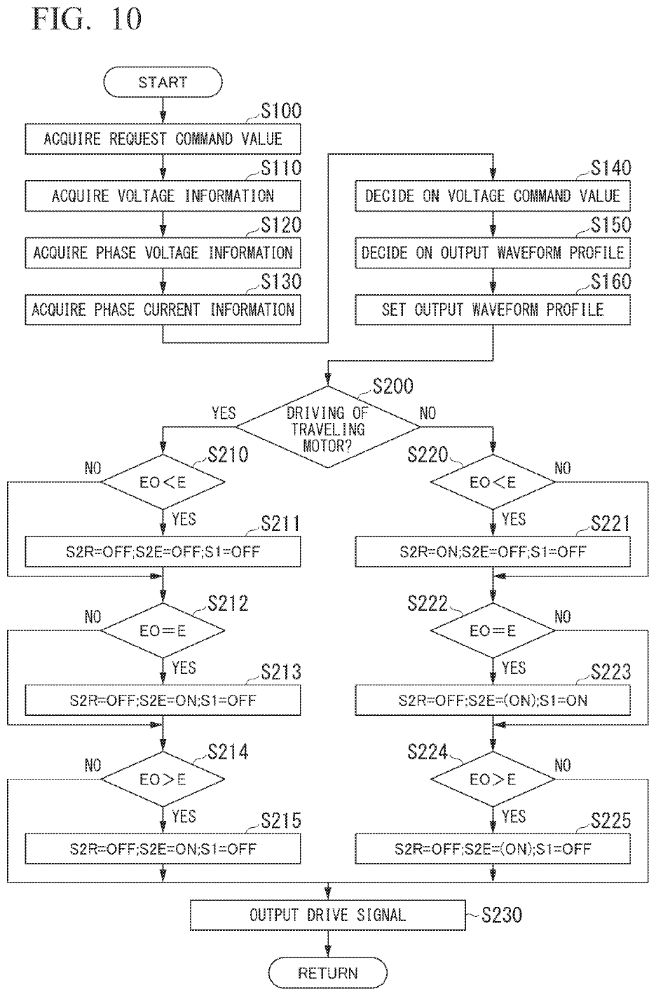

FIG. 10 is a flowchart showing an example of a flow of a process executed by the controller 350. The process of the present flowchart is iteratively executed while the vehicle 1 is traveling.

The voltage command value determiner 352 acquires a request command value output by the control device 100 (step S100). The voltage command value determiner 352 acquires voltage information of the output voltage E1 and the output voltage E2 output by each power converter 300 (step S110). The voltage command value determiner 352 acquires phase voltage information of an AC voltage EO output by each power converter 300 (step S120). The voltage command value determiner 352 acquires phase current information of the AC voltage EO output by each power converter 300 (step S130). The voltage command value determiner 352 decides on a voltage command value of the AC voltage EO to be subsequently output to each power converter 300 on the basis of the acquired information (step S140).

The output waveform profile determiner 354 decides on an output waveform profile to be set in the converter 322 of the voltage waveform generator 320 provided in each power converter 300 on the basis of the voltage command value decided on by the voltage command value determiner 352 (step S150). The output waveform profile determiner 354 inputs or sets the decided output waveform profile to or in each voltage waveform generator 320 (step S160). More specifically, the output waveform profile determiner 354 outputs information of the decided output waveform profile as a converter control signal and sets it in the voltage waveform generator 320. Thereby, when the current control is control for driving the traveling motor 10 for traveling of the vehicle 1, each voltage waveform generator 320 allows the output voltage E2 corresponding to the voltage command value decided on by the voltage command value determiner 352 to be output to the traveling motor 10 side. On the other hand, when the current control is control for charging the battery 20 with electric power generated by the traveling motor 10, each voltage waveform generator 320 allows an output voltage based on electric power generated by the traveling motor 10 corresponding to the voltage command value decided on by the voltage command value determiner 352 to be output to the battery 20 side.

The controller 350 determines whether or not the current control is control for driving of the traveling motor 10 (step S200). That is, the controller 350 determines whether the current control is control for driving the traveling motor 10 for traveling of the vehicle 1 or control for charging the battery 20 with the electric power generated by the traveling motor 10. When it is determined that the current control is control for driving the traveling motor 10 in step S200, the controller 350 starts the control for driving the traveling motor 10 for the traveling of the vehicle 1.

In the control for driving the traveling motor 10 for traveling of the vehicle 1, the switching controller 356 confirms whether the AC voltage value of the AC voltage EO is a voltage value (EO<E) smaller than the DC voltage value of the DC voltage E capable of being supplied from the battery 20 (step S210 ). When it is determined that the AC voltage value of the AC voltage EO is not the voltage value of (EO<E) in step S210, the switching controller 356 moves the process to step S212.

On the other hand, when it is determined that the AC voltage value of the AC voltage EO is the voltage value of (EO<E) in step S210, the switching controller 356 generates drive signals for setting the switching element S2R in the OFF state (the non-conductive state), setting the switching element S2E in the OFF state, and setting the switching element S1 in the OFF state (step S211). That is, the switching controller 356 switches the state to the state of control C1 (see (b) of FIG. 5).

The switching controller 356 confirms whether or not the AC voltage value of the AC voltage EO is a voltage value (EO=E) equal to the DC voltage value of the DC voltage E capable of being supplied from the battery 20 (step S212). When it is determined that the AC voltage value of the AC voltage EO is not the voltage value of (EO=E) in step S212, the switching controller 356 moves the process to step S214.

On the other hand, when it is determined that the AC voltage value of the AC voltage EO is the voltage value of (EO=E) in step S212, the switching controller 356 generates drive signals for setting the switching element S2R in the OFF state, setting the switching element S2E in the ON state (the conductive state), and setting the switching element S1 in the OFF state (step S213). That is, the switching controller 356 switches the state to the state of control C2 (see (b) of FIG. 5).

The switching controller 356 confirms whether or not the AC voltage value of the AC voltage EO is a voltage value (EO>E) larger than the DC voltage value of the DC voltage E capable of being supplied from the battery 20 (step S214). When it is determined that the AC voltage value of the AC voltage EO is not the voltage value of (EO>E) in step S214, the switching controller 356 moves the process to step S230.

On the other hand, when it is determined that the AC voltage value of the AC voltage EO is the voltage value of (EO>E) in step S214, the switching controller 356 generates drive signals for setting the switching element S2R in the OFF state, setting the switching element S2E in the ON state, and setting the switching element S1 in the OFF state (step S215). That is, the switching controller 356 maintains the final state of control C2 (see (b) of FIG. 5).

On the other hand, when it is determined that the current control is not control for driving the traveling motor 10 in step S200, the controller 350 starts control for charging the battery 20 with the electric power generated by the traveling motor 10.

In the control for charging the battery 20 with the electric power generated by the traveling motor 10, the switching controller 356 confirms whether or not the AC voltage value of the AC voltage EO is a voltage value (EO<E) smaller than the DC voltage value of the DC voltage E capable of being supplied from the battery 20 (step S220). When it is determined that the AC voltage value of the AC voltage EO is not the voltage value of (EO<E) in step S220, the switching controller 356 moves the process to step S222.

On the other hand, when it is determined that the AC voltage value of the AC voltage EO is the voltage value of (EO<E) in step S220, the switching controller 356 generates drive signals for setting the switching element S2R in the ON state (the conductive state), setting the switching element S2E in the OFF state (the non-conductive state), and setting the switching element Si in the OFF state (step S221). That is, the switching controller 356 switches the state to the state of control C1′ (see (c) of FIG. 5).

The switching controller 356 confirms whether or not the AC voltage value of the AC voltage EO is a voltage value (EO=E) equal to the DC voltage value of the DC voltage E capable of being supplied from the battery 20 (step S222). When it is determined that the AC voltage value of the AC voltage EO is not the voltage value of (EO=E) in step S222, the switching controller 356 moves the process to step S224.

On the other hand, when it is determined that the AC voltage value of the AC voltage EO is the voltage value of (EO=E) in step S222, the switching controller 356 generates drive signals for setting the switching element S2R in the OFF state, setting the switching element S2E in the ON state (or maintaining the switching element S2E in the OFF state), and setting the switching element S1 in the ON state (step S223). That is, the switching controller 356 switches the state to the state of control C2′ (see (c) of FIG. 5).

The switching controller 356 confirms whether or not the AC voltage value of the AC voltage EO is a voltage value (EO>E) larger than the DC voltage value of the DC voltage E capable of being supplied from the battery 20 (step S224). When it is determined that the AC voltage value of the AC voltage EO is not the voltage value of (EO>E) in step S224, the switching controller 356 moves the process to step S230.

On the other hand, when it is determined that the AC voltage value of the AC voltage EO is the voltage value of (EO>E) in step S224, the switching controller 356 generates drive signals for setting the switching element S2R in the OFF state, setting the switching element S2E in the ON state (or maintaining the switching element S2E in the OFF state), and setting the switching element S1 in the OFF state (step S225). That is, the switching controller 356 maintains the final state of control C2′ (see (c) of FIG. 5).

The switching controller 356 outputs each generated drive signal to the switching element of each corresponding power converter 300 (step S230). The controller 350 ends the current process and iterates the process again from step S100 shown in FIG. 10.

According to such a processing flow, the controller 350 acquires the request command value output by the control device 100, the voltage information of the output voltage E1 and the output voltage E2 output by each power converter 300, and the phase voltage information and the phase current information of the AC voltage EO output by the power converter 300 and inputs or sets an output waveform profile to or in the voltage waveform generator 320. The switching controller 356 provided in the controller 350 generates and outputs a drive signal for setting each switching element in the ON state (the conductive state) or the OFF state (the non-conductive state) on the basis of the AC voltage value of the AC voltage EO. Thereby, the power converter 300 operates according to a control process of the controller 350 to supply the electric power for traveling of the vehicle 1 to the traveling motor 10 or allows the battery 20 to be charged with the electric power generated by the traveling motor 10.

According to such a configuration, the power conversion device 30 doubles the voltage of the DC power supplied (discharged) from the battery 20 at most in accordance with the control process of the controller 350, converts the doubled voltage into an AC voltage for driving the traveling motor 10, and outputs the AC voltage to the traveling motor 10. Moreover, when the power conversion device 30 boosts the DC power from the battery 20 and outputs the boosted DC power to the traveling motor 10, a voltage obtained by waveform-synthesizing the output voltage E1 of a rectangular voltage waveform based on the DC power when the battery 20 is discharged with the output voltage E2 of the voltage waveform generated on the basis of the output waveform profile from the DC power when the battery 20 is discharged as shown in FIG. 4 is output to the traveling motor 10. That is, the power conversion device 30 supplies the AC voltage EO obtained by accumulating the output voltage E1 output by the rectangular voltage generator 310 and the output voltage E2 output by the voltage waveform generator 320 between the phases of the traveling motor 10. Thereby, the traveling motor 10 is supplied with an AC voltage obtained by performing a final differential synthesis process between the phases (between the terminals) of the traveling motor 10. In other words, in the power conversion device using a conventional inverter, it is necessary to provide a boost chopper or the like in a stage previous to the inverter, i.e., it is necessary to configure the converter in two stages. However, the power conversion device 30 includes the converter 322, i.e., the power conversion device 30 can be implemented with only a one-stage converter. Therefore, the power conversion device 30 can limit the deterioration of the power conversion efficiency as compared with that of the conventional configuration including a two-stage converter even if the reduction rate of the power conversion efficiency between the conventional inverter and the converter 322 is the same. More specifically, for example, when the power conversion efficiencies of both the inverter and the converter 322 are 98%, the total conversion efficiency of the power conversion device using the conventional inverter becomes 98%. When a two-stage converter is used in a conventional power conversion device, the overall conversion efficiency is further reduced to 96%. On the other hand, in the power conversion device 30, because the DC voltage of the battery 20 is simply switched, the output voltage E1 whose conversion efficiency can be said to be substantially 100% is combined with the output voltage E2 whose conversion efficiency is 98% output by the converter 322. Thus, in the power conversion device 30, assuming that the ratio between the output voltage E1 and the output voltage E2 is fifty-fifty, the total conversion efficiency becomes 99%. As described above, in the power conversion device 30, the overall conversion efficiency is higher than that of the conventional power conversion device in which the inverter is used and the boost chopper is connected in series to the inverter, i.e., the deterioration of the power conversion efficiency can be limited.

As shown in FIG. 4, the power conversion device 30 can generate an AC amplitude having a voltage value that is twice a DC voltage value when the battery 20 is discharged at maximum by performing waveform synthesis. Although it is necessary to configure an inverter using, for example, a component of a high withstand voltage increased by a factor of 2, to cope with a battery that is discharged to supply power of the same voltage value when the value of a voltage supplied to the traveling motor 10 is 600 [V], for example, in the power conversion device using the conventional inverter, it is only necessary to adopt a configuration corresponding to a battery that is discharged to supply power of a voltage value of 300 [V] (a half-voltage value) in the power conversion device 30 and it is possible to configure the power conversion device 30 using a component having a lower withstand voltage than a conventional component. Thus, in the power conversion device 30, it is possible to limit an increase in loss due to the use of a high withstand voltage component. In the power conversion device 30, because the voltage applied to each of the constituent components is lower than a conventional voltage, the deterioration of each component such as, for example, an insulating member or a winding of a transformer, can be limited.

Further, because the converter 322 generates an output voltage E2 (see (b) of FIG. 4) of a voltage waveform for reproducing sinusoidal waves (sinusoidal waves having positive values) on the basis of an output waveform profile, the power conversion device 30 does not generate harmonics that are generated in the power conversion process of the conventional inverter. Thus, in the power conversion device 30, the AC waveform of the AC voltage supplied to the traveling motor 10 is not distorted and characteristics such as noise, torque ripple, and iron loss are not affected.

Even in a power conversion device using a conventional inverter, a configuration in which the generation of harmonics is limited can be implemented by providing a smoothing filter such as, for example, an LC filter, in a stage further subsequent to the boost chopper provided in a stage subsequent to the inverter. However, it is difficult to implement a configuration in which the constant is variable in the LC filter and a physical size becomes large when the voltage waveform has a low frequency or the power capacity is large. Thus, a configuration in which an LC filter is provided as a countermeasure against harmonics generated in a power conversion device using a conventional inverter is a configuration suitable for the application to a system that converts power in a constant state such as a constant voltage constant frequency (CVCF) power supply and is not suitable for the application of a system of a variable voltage variable frequency (VVVF) power supply in which a range of a frequency of power of sinusoidal waves to be supplied when the traveling motor 10 is driven (rotated) as in the vehicle 1 is wide. This is because it is necessary to change the voltage waveform of power for driving the traveling motor 10 in a wide range from a low frequency to a high frequency so that high torque is generated from a state in which the rotational speed of the traveling motor 10 is zero when the vehicle 1 starts from a stopped state and the traveling motor 10 is driven at a high rotational speed when the vehicle 1 is allowed to travel at the maximum speed. A conventional inverter provided with an LC filter can be applied to the vehicle 1 as a power conversion device. However, in this case, as described above, because the frequency range of the voltage required to be supplied to the traveling motor 10 is wide, it is necessary to increase the physical size of the LC filter. Further, when a process of converting the DC power supplied (discharged) from the battery 20 into AC power for operating household electric appliances at the time of emergency or the like or for supplying power to a power system in an electric power selling process or the like is taken into consideration, it is unnecessary to provide an LC filter as in the power conversion device using a conventional inverter and it can be said that the configuration of the power conversion device 30 that can directly supply power is a more effective configuration.

In this way, the power conversion device 30 can perform power conversion more efficiently than a power conversion device using the conventional inverter.

### Modified Examples of Power Conversion Device

A configuration in which the above-described power conversion device 30 outputs an AC voltage EO obtained by accumulating an output voltage E1 output by the rectangular voltage generator 310 and an output voltage E2 output by the voltage waveform generator 320, i.e., a configuration in which the above-described power conversion device 30 accumulates output voltages based on the DC voltage E capable of being supplied from the battery 20 in two stages and outputs an accumulation result, has been described. However, the number of stages of output voltages based on the DC voltage E capable of being supplied from the battery 20 accumulated to output the AC voltage EO is not limited to two. That is, it is possible to configure a power conversion device for generating an AC amplitude of an AC voltage value that is at most three times or more the DC voltage value when the battery 20 is discharged by accumulating the output voltages based on the DC voltage E capable of being supplied from the battery 20 in three stages or more. An example in this case will be described below.

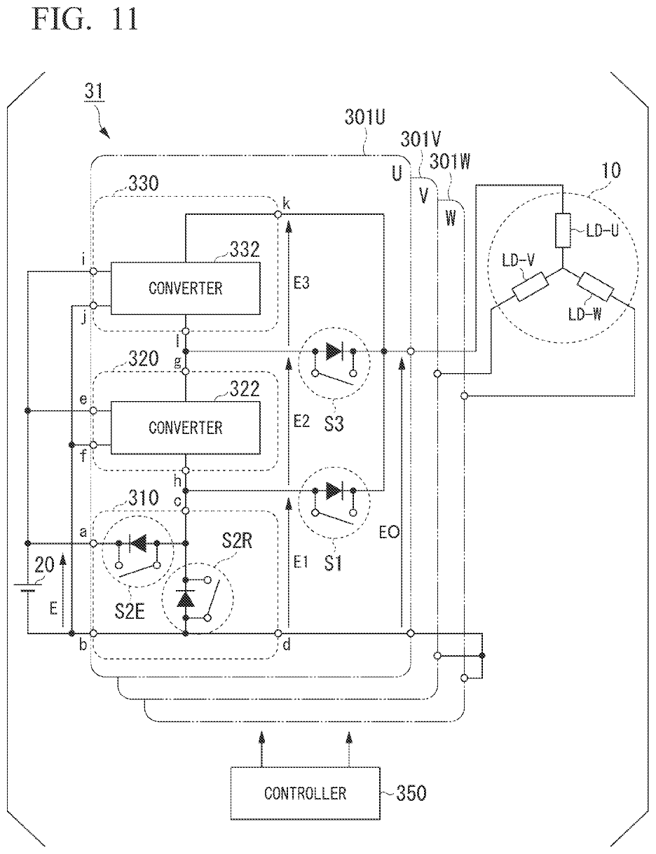

FIG. 11 is a diagram showing an example of a configuration of the power conversion device 31 according to a modified example. In FIG. 11, the battery 20 and the traveling motor 10 related to the power conversion device 31 are also shown. The power conversion device 31 shown in FIG. 11 also has a configuration corresponding to the traveling motor 10 that is a three-phase AC motor. The power conversion device 31 includes, for example, three power converters 301 (a power converter 301U, a power converter 301V, and a power converter 301W) and a controller 350. In the following description, when the power converter 301U, the power converter 301V, and the power converter 301W are not distinguished from each other, it is simply referred to as a “power converter 301.”

Like the power converter 300, the power converter 301 converts the DC power supplied (discharged) from the battery 20 into an AC voltage having a voltage waveform represented by a sinusoidal wave having a positive value and outputs the AC voltage at the corresponding phase of the traveling motor 10. The power converter 301 includes, for example, a rectangular voltage generator 310, a voltage waveform generator 320, a rectangular voltage generator 330, a switching element S1, and a switching element S3. The rectangular voltage generator 310 includes, for example, a converter 332. The power converter 301 has a configuration in which the rectangular voltage generator 330 and the switching element S3 are added to the power converter 300.

The rectangular voltage generator 330 converts the DC power supplied (discharged) from the battery 20 into output power (a rectangular pulse) of the rectangular voltage waveform in accordance with a control process of the controller 350 and outputs the output power. The rectangular voltage generator 330 outputs an output voltage E3 obtained by converting a DC voltage E supplied between a first end i and a second end j by the battery 20 on the basis of an output waveform profile between a third end k and a fourth end 1.

The converter 332 outputs 0 [V] or the output voltage E3 of a rectangular voltage waveform having a DC voltage value of the DC voltage E at a timing different from that of a voltage waveform of the output voltage E1 output by the rectangular voltage generator 310 in accordance with a control process of the controller 350. The converter 332 is a converter having a configuration for generating a rectangular pulse. The converter 332 is, for example, a bridge type or push-pull type bidirectional isolated DC-DC converter configured in advance such that the output voltage E3 to be output has a rectangular voltage waveform. The converter 332 may be configured to output the output voltage E3 when the controller 350 controls the conductive state and the non-conductive state of the switching element like the rectangular voltage generator 310 or may output the output power of the voltage waveform on the basis of the output waveform profile input or set by the controller 350 like the converter 322 provided in the voltage waveform generator 320. When the converter 332 has a configuration similar to that of the rectangular voltage generator 310, the converter 332 includes a switching element (a switching circuit) that performs a switching operation equivalent to that of the switching element S2E or the switching element S2R. When the converter 332 has a configuration similar to that of the converter 322 provided in the voltage waveform generator 320, a voltage command value different from that of the output waveform profile input or set to or in the converter 322 or an output waveform profile (hereinafter referred to as a “second output waveform profile”) indicating the voltage command value is sequentially input or set to or in the converter 332 by the controller 350. The second output waveform profile input or set to or in the converter 332 may also be sequentially input or set by, for example, the controller 350.

The rectangular voltage generator 330 (which may be the converter 332) is an example of a “third converter” in the claims. The third end k is an example of a “one end of a third terminal pair” in the claims and the fourth end 1 is an example of an “another end of the third terminal pair” in the claims. The output voltage E3 is an example of “fourth output power” in the claims and the voltage waveform of the output voltage E3 is an example of a “third voltage waveform” in the claims.

The switching element S3 is connected between the third end g of the voltage waveform generator 320 and the fourth end 1 of the rectangular voltage generator 330 and the third end k of the rectangular voltage generator 330 and the switching element S1 and limits a direction in which an output voltage output from the power converter 301 is supplied in accordance with a process of controlling the conductive state and the non-conductive state in the controller 350. Thereby, like the switching element S1, the switching element S3 switches the direction of the voltage supplied between the power converter 301 and the traveling motor 10. When the controller 350 controls the switching element S3 such that it is in the non-conductive state, the output voltage output from the power converter 301 is allowed to be supplied to the load LD side (i.e., the traveling motor 10) and the voltage output from the load LD side is prevented from being supplied to the power converter 301 side (particularly, the rectangular voltage generator 330). On the other hand, when the controller 350 controls the switching element S3 such that it is in the conductive state, the voltage output from the load LD side is allowed to be supplied to the rectangular voltage generator 330. The controller 350 controls the switching element S3 such that it is in the non-conductive state like the switching element S1 when the traveling motor 10 for traveling of the vehicle 1 is driven and controls the switching element S3 such that it is in the conductive state like the switching element S1 when the battery 20 is charged with electric power generated by the traveling motor 10 operating as the regenerative brake. However, a timing when the controller 350 controls the switching element S3 such that it is in the conductive state or the non-conductive state is different from a timing when the controller 350 controls the switching element S1 such that it is in the conductive state or the non-conductive state. The switching element S3 is an example of a “fourth switching element” in the claims.

Although an example in which the switching element S3 includes a diode and a switch is shown in FIG. 11, the switching element S3 may include a field effect transistor FET or a diode D and an insulated gate bipolar transistor IGBT like the switching element S1 or the switching element S2E and the switching element S2R (see FIG. 3).

According to such a configuration, in the power conversion device 31, the controller 350 controls each power converter 301. The power converter 301 outputs the AC voltage EO obtained by converting the DC voltage E supplied (discharged) from the battery 20 between the fourth end d and the third end k, which are output terminals of the power converter 301, in accordance with a control process of the controller 350. That is, the power converter 301 supplies the load LD side (i.e., the traveling motor 10) with an output voltage E2 obtained in a conversion process of the voltage waveform generator 320, an output voltage obtained by combining the output voltage E2 obtained in the conversion process of the voltage waveform generator 320 and an output voltage E1 obtained in the conversion process of the rectangular voltage generator 310, or an output voltage obtained by combining the output voltage E2 obtained in the conversion process of the voltage waveform generator 320, the output voltage E1 obtained in the conversion process of the rectangular voltage generator 310, and an output voltage E3 obtained in the conversion process of the rectangular voltage generator 330 as the AC voltage EQ. Thereby, when the power conversion device 31 outputs the AC voltage EO obtained by combining the output voltage E1, the output voltage E2, and the output voltage E3, it is possible to generate an AC amplitude of a voltage value that is at most three times the DC voltage E of the battery 20. Because fourth ends d, which are output terminals of the power converter 301U, the power converter 301V, and the power converter 301W, are connected to each other as shown in FIG. 11 even in the power conversion device 31, AC voltages EO output by any two power converters 301 among the power converter 301U, the power converter 301V, and the power converter 301W are differentially synthesized and the traveling motor 10 is supplied with a voltage of a differential synthesis result between the phases. The power converter 301 is also an example of a “power converter” in the claims and the AC voltage EO output by the power converter 301 is also an example of “third output power” in the claims. A voltage waveform of the AC voltage EO output by the power converter 301 is also an example of a “control waveform” in the claims.

### Voltage Waveform Generated by Power Conversion Device of Modified Example

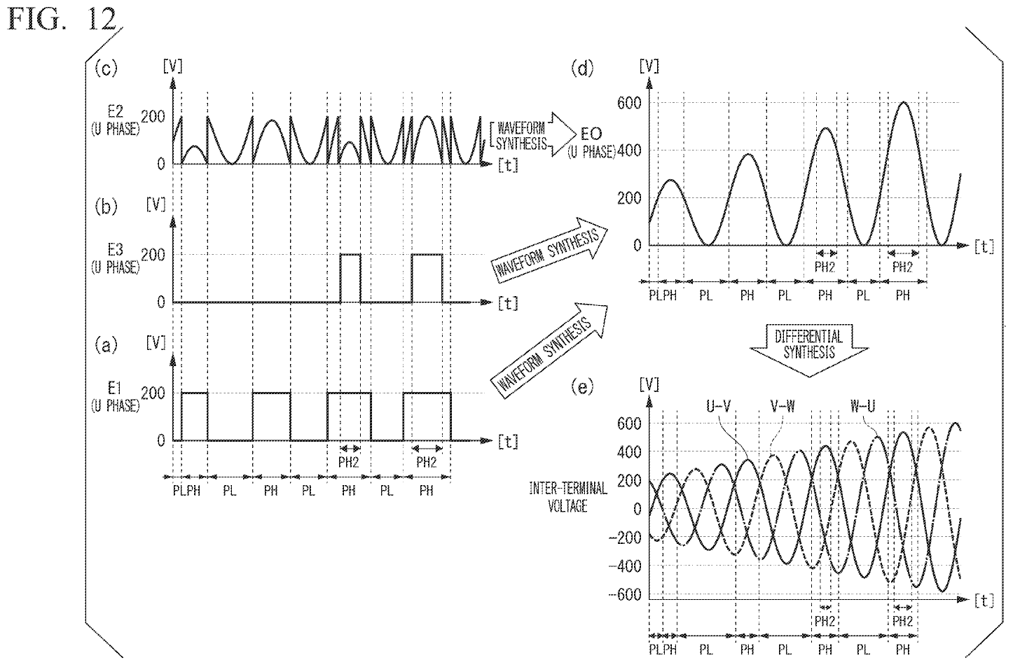

FIG. 12 is a diagram showing an example of a voltage waveform generated by the power conversion device 31 of a modified example. In FIG. 12, an example of the voltage waveform of the output voltage generated at each location in the configuration diagram of the power conversion device 31 shown in FIG. 11 is shown.

Even in the power conversion device 31, the controller 350 generates a voltage command value for generating and outputting the output voltage E1 of a rectangular voltage waveform (a rectangular pulse) as shown in (a) of FIG. 12 or an output waveform profile indicating the voltage command value by controlling the switching element S2E and the switching element S2R of the rectangular voltage generator 310 provided in each power converter 301. In (a) of FIG. 12, an example in which the low-level voltage value generated by the rectangular voltage generator 310 during the low-level period PL is 0 [V] and the high-level voltage value during the high-level period PH is an output voltage E1 of a rectangular pulse having a DC voltage value (200 [V] in (a) of FIG. 12) of the battery 20 is shown. The voltage waveform of the output voltage E1 shown in (a) of FIG. 12 is an example of a case where the rectangular voltage generator 310 provided in the power converter 301U generates and outputs a voltage.

In the power conversion device 31, the controller 350 allows the output voltage E3 of the rectangular voltage waveform (the rectangular pulse) as shown in (b) of FIG. 12 to be generated and output by controlling the converter 332 of the rectangular voltage generator 330 provided in each power converter 301 on the basis of the generated voltage command value or the output waveform profile indicating the voltage command value. The voltage waveform of the output voltage E3 shown in (b) of FIG. 12 is an example of a case where the voltage waveform generator 320 provided in the power converter 301U generates and outputs a voltage waveform. The voltage command value (or the second output waveform profile) in which the controller 350 controls the converter 332 of the rectangular voltage generator 330 is used to generate the output voltage E3 of the rectangular pulse serving as the DC voltage value during a period in which an AC voltage EO of a voltage value exceeding the DC voltage value that is at most twice the DC voltage E of the battery 20 is output in a voltage waveform (see (d) of FIG. 12) of the AC voltage EO represented by a sinusoidal wave having a positive value output by the power conversion device 31. More specifically, the controller 350 generates a voltage command value of a rectangular pulse in which the voltage value of the output voltage E3 becomes a DC voltage value during a second high-level period PH2 in which the AC voltage value of the AC voltage EO exceeds a DC voltage value that is twice the DC voltage E of the battery 20 within the high-level period PH and the voltage value of the output voltage E2 becomes 0 [V] during the other period, i.e., a period in which the AC voltage value of the AC voltage EO does not exceed the DC voltage value that is twice the DC voltage E of the battery 20. The controller 350 controls the operation of the converter 332 of the rectangular voltage generator 330 provided in the power converter 301U on the basis of the generated voltage command value (or the second output waveform profile). Thereby, the rectangular voltage generator 330 generates and outputs the output voltage E3 of the rectangular pulse in which the low-level voltage value is 0 [V] and the high-level voltage value is the DC voltage value (200 [V] in (b) of FIG. 12) of the battery 20 as shown in (b) of FIG. 12.

In the power conversion device 31, the controller 350 generates a voltage command value for generating the output voltage E2 of the voltage waveform obtained by subtracting a voltage waveform (a rectangular pulse) of each of the output voltage E1 output by the rectangular voltage generator 310 and the output voltage E3 output by the rectangular voltage generator 330 from a voltage waveform (see (d) of FIG. 12) of the AC voltage EO represented by a sinusoidal wave having a positive value output by the power conversion device 31. The controller 350 allows the output voltage E2 of the voltage waveform as shown in (c) of FIG. 12 to be generated and output by inputting or setting the generated voltage command value as an output waveform profile to or in the voltage waveform generator 320 provided in each power converter 301. More specifically, the controller 350 allows the voltage waveform generator 320 to generate and output the output voltage E2 of the voltage waveform in which the voltage value of the output voltage E2 is reduced by the voltage value of the output voltage E1 during the high-level period PH and the voltage value of the output voltage E2 is further reduced by a sum of the voltage value of the output voltage E1 and the voltage value of the output voltage E3 during the second high-level period PH2 as shown in (b) of FIG. 12. The voltage waveform of the output voltage E2 shown in (c) of FIG. 12 is an example of a case where the voltage waveform generator 320 provided in the power converter 301U generates and outputs a voltage waveform.

In this way, in the power conversion device 31, the controller 350 allows the rectangular voltage generator 310 to output the output voltage E1, allows the voltage waveform generator 320 to output the output voltage E2, and allows the rectangular voltage generator 330 to output the output voltage E3. In the power conversion device 31, the output voltage E1 output by the rectangular voltage generator 310, the output voltage E3 output by the rectangular voltage generator 330, and the output voltage E2 output by the voltage waveform generator 320 are combined on the load LD side of the switching element S1 and the switching element S3 provided in the power converter 301. At this time, in the power conversion device 31, the controller 350 allows the rectangular voltage generator 310 to output the output voltage E1, and allows the rectangular voltage generator 330 to output the output voltage E3, according to a timing when the voltage waveform generator 320 outputs the output voltage E2. Thereby, in the power conversion device 31, an AC voltage EO in which the voltage waveform of the output voltage E1, the voltage waveform of the output voltage E3, and the voltage waveform of the output voltage E2 are waveform-synthesized is output from each power converter 301. Thereby, as shown in (d) of FIG. 12, an AC voltage EO of a voltage waveform represented by a sinusoidal wave having a positive value within a voltage value (600 [V] in (d) of FIG. 12) that is at most three times the DC voltage value when the battery 20 is discharged is supplied to the load LD side (i.e., the traveling motor 10). The voltage waveform of the AC voltage EO shown in (d) of FIG. 12 is an example of a voltage waveform of the AC voltage EO output by the power converter 301U.

AC voltages EO output at phases by the power converters 301 provided in the power conversion device 31 are differentially synthesized and an AC voltage (an inter-terminal voltage U-V, an inter-terminal voltage V-W, and an inter-terminal voltage W-U) of a voltage waveform represented by a sinusoidal wave having positive and negative values using an inter-terminal voltage=0 [V] as a reference voltage as shown in (e) of FIG. 12 is supplied to the traveling motor 10 between the phases. Thereby, the traveling motor 10 is driven (rotated) with an AC voltage of a sinusoidal wave supplied between the phases.

### Operation of Power Conversion Device of Modified Example

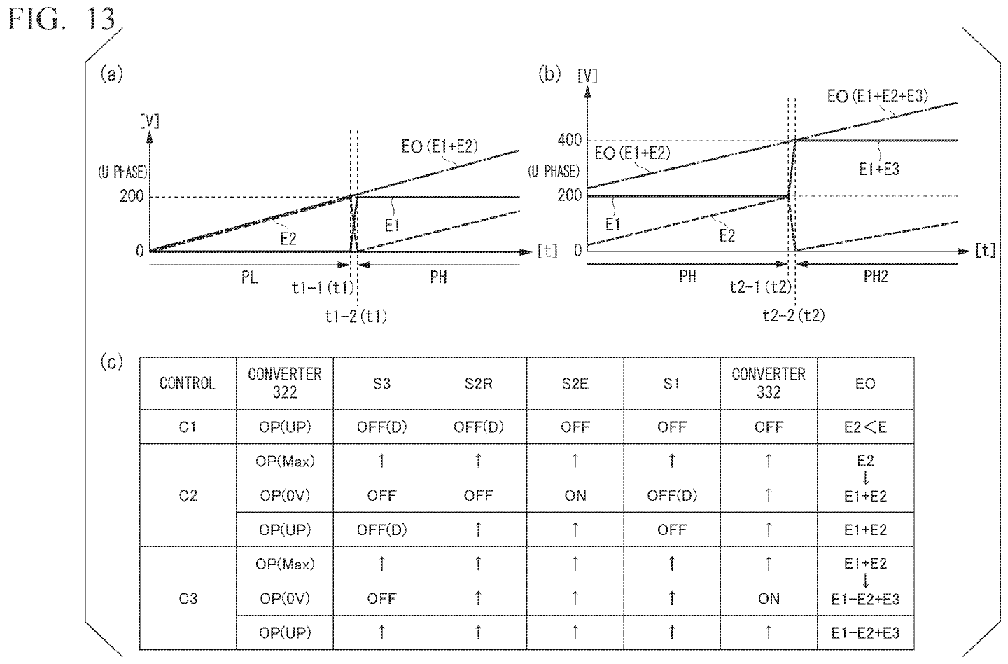

Here, a control process of the controller 350 performed when the voltage waveform of the output voltage E1, the voltage waveform of the output voltage E3, and the voltage waveform of the output voltage E2 are waveform-synthesized in the power conversion device 31 will be described. FIG. 13 is a diagram showing an example of a detailed timing when the controller 350 provided in the power conversion device 31 of the modified example controls the power converter 301 and a control process. In (a) of FIG. 13, an example of a state in which voltage waveforms of the output voltage E1, the output voltage E2, and the AC voltage EO change at a timing (see, for example, (d) of FIG. 12) of transition from the low-level period PL to the high-level period PH is shown. In (b) of FIG. 13, an example of a state in which voltage waveforms of the output voltage E1, the output voltage E2, the output voltage E3, and the AC voltage EO change at a timing (see, for example, (d) of FIG. 12) of transition from the high-level period PH to the second high-level period PH2 is shown. In (c) of FIG. 13, the state of each switching element controlled by the controller 350 is shown. (c) of FIG. 13 is an example of a case where the traveling motor 10 for traveling of the vehicle 1 is driven. In (c) of FIG. 13, “ON” of the converter 332 indicates that a control process of outputting the output voltage E3 of the high-level voltage value (a DC voltage value of the battery 20) is performed, “OFF” thereof indicates that a control process of outputting the output voltage E3 of the low-level voltage value (0 [V]) is performed, and “↑: Up arrow” indicates that the control of the operation of the converter 332 has not been changed. Other content in (c) of FIG. 13 is similar to that in (b) of FIG. 5 and (c) of FIG. 5.

First, a control process of the controller 350 at a timing of transition from the low-level period PL to the high-level period PH will be described with reference to (a) of FIG. 13. During the low-level period PL shown in (a) of FIG. 13, i.e., at the time of a state in which an AC voltage value of the AC voltage EO (which may be the voltage value of the output voltage E2) is smaller than a DC voltage value of the DC voltage E supplied from the battery 20, the controller 350 performs a control process such that each of the switching element S3, the switching element S2E, the switching element S2R, and the switching element S1 is in the non-conductive state as in the field of control C1 shown in (c) of FIG. 13. Thereby, the power converter 301 outputs the output voltage E2 output by the converter 322 as the AC voltage EO during a period that is the low-level period PL. In the power converter 301, the voltage value of the output voltage E2 (i.e., the AC voltage value of the AC voltage EO) increases on the basis of the output waveform profile input or set by the controller 350 to or in the voltage waveform generator 320. At this time, the output voltage E1 output by the rectangular voltage generator 310 is also output through the diode D provided in the switching element S1 and the output voltage E3 output by the rectangular voltage generator 330 is also output through the diode D provided in the switching element S3, but the output voltage E1 and the output voltage E3 do not affect the AC voltage value of the AC voltage EO because the output voltage E1 and the output voltage E3 are 0 [V].

Subsequently, the controller 350 controls each of the switching element S3, the switching element S2E, the switching element S2R, and the switching element S1 as in the field of control C2 shown in (c) of FIG. 13 at a timing of time t1 of transition from the low-level period PL to the high-level period PH shown in (a) of FIG. 13. Here, the controller 350 allows the rectangular voltage generator 310 to output the output voltage E1 of a rectangular voltage waveform (a rectangular pulse) by controlling the switching element S2E such that it is in the conductive state. Thereby, in the power converter 301, an output voltage E1 of a rectangular voltage waveform (a rectangular pulse) output by the rectangular voltage generator 310 is output through the diode D provided in the switching element S1 and the supply of an AC voltage EO obtained by waveform-synthesizing the voltage waveform of the output voltage E1 and the voltage waveform of the output voltage E2 (i.e., an AC voltage EO obtained by combining the output voltage E1 and the output voltage E2) to the load LD side (the traveling motor 10) is started. Even at this time, the output voltage E3 output by the rectangular voltage generator 330 is output through the diode D provided in the switching element S3, but the output voltage E3 does not affect the AC voltage value of the AC voltage EO because the output voltage E3 is 0 [V]. Because a control process and timing for each component in the controller 350 at a timing of time t1 are similar to a control process and timing at the timing of time t1 described with reference to (a) and (b) of FIG. 5, a detailed description will be omitted.

Subsequently, a control process of the controller 350 at a timing of transition from the high-level period PH to the second high-level period PH2 will be described with reference to (b) of FIG. 13. At a timing of time t2 of transition from the high-level period PH to the second high-level period PH2 shown in (b) of FIG. 13, the controller 350 controls each of the switching element S3, the switching element S2E, the switching element S2R, and the switching element S1 as in the field of control C3 shown in (c) of FIG. 13. Here, the controller 350 further allows the rectangular voltage generator 330 to output the output voltage E3 of the rectangular voltage waveform (the rectangular pulse). Thereby, in the power converter 301, the output voltage E3 of the rectangular voltage waveform (the rectangular pulse) output by the rectangular voltage generator 330 is output through the diode D provided in the switching element S3 and an AC voltage EO obtained by waveform-synthesizing the voltage waveform of the output voltage E3 with a voltage waveform in which the voltage waveform of the output voltage E2 and the voltage waveform of the output voltage E1 are waveform-synthesized is output.

More specifically, when the AC voltage value of the AC voltage EO has increased to a voltage value (400 [V] in (b) of FIG. 13) equivalent to twice the DC voltage value of the DC voltage E, i.e., at a timing of time t2-1 when the voltage value of the output voltage E2 output by the converter 322 has become a maximum value (200 [V] in (b) of FIG. 13) again, the controller 350 performs a control process such that the converter 332 is allowed to output the output voltage E3 of the voltage value of the high level. Thereby, the output of the output voltage E3 based on the DC voltage E from the rectangular voltage generator 330 is started and the voltage value of the output voltage E3 becomes the DC voltage value of the DC voltage E supplied from the battery 20 between time t2-1 and time t2-2. In the power converter 301, the voltage waveform of the output voltage E3 is further waveform-synthesized and the supply of the AC voltage EO obtained by combining the output voltage E1, the output voltage E2, and the output voltage E3 to the load LD side (i.e., the traveling motor 10) is started from a timing of time t2-2 when the voltage value of the output voltage E2 output by the voltage waveform generator 320 on the basis of the output waveform profile becomes 0 [V].

In the second high-level period PH2 shown in (b) of FIG. 13, the AC voltage value of the AC voltage EO obtained by combining the output voltage E1, the output voltage E2, and the output voltage E3 is further increased according to an increase in the voltage value of the output voltage E2 output by the voltage waveform generator 320 on the basis of the output waveform profile.

In this way, in the power conversion device 31, a waveform synthesis process for the voltage waveform of the output voltage E2 and the voltage waveform of the output voltage E1 or a waveform synthesis process for the voltage waveform of the output voltage E2, the voltage waveform of the output voltage E1, and the voltage waveform of the output voltage E3 is performed in each power converter 301 in accordance with a control process of the controller 350. Thereby, in the power conversion device 31, the AC voltage value of the AC voltage EO output by each power converter 301 is increased to a voltage value (a maximum of 600 [V] in (b) of FIG. 13) that is at most three times the DC voltage E of the battery 20.

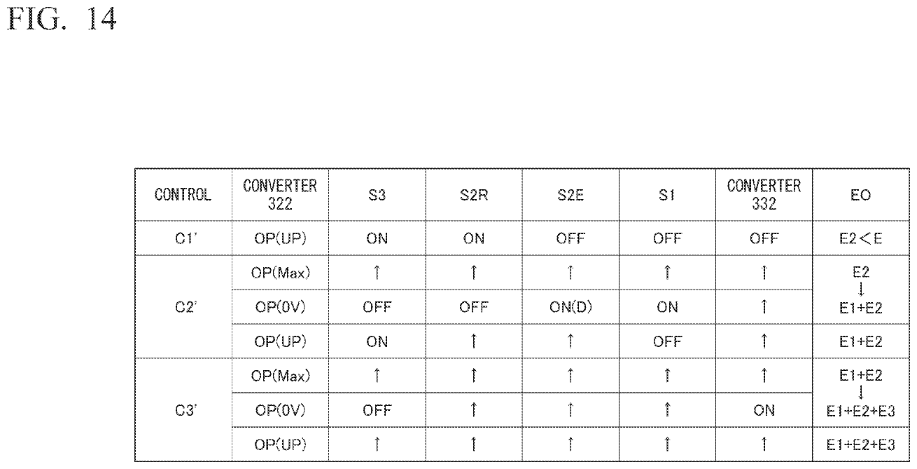

The controller 350 also performs a similar control process even if the battery 20 is charged with electric power generated when the traveling motor 10 operates as the regenerative brake. FIG. 14 is a diagram showing an example of a control process in which the controller 350 provided in the power conversion device 31 of the modified example controls the power converter 301. In FIG. 14, control C1′, control C2′, and control C3′ are processes of controlling switching elements corresponding to control C1, control C2, and control C3 shown in (c) of FIG. 13. The operation of the controller 350 in this case may be equivalent to a reverse operation associated with the operation of driving the traveling motor 10 for traveling of the vehicle 1 described above. Accordingly, a detailed description of the control process of the controller 350 when the battery 20 is charged with electric power generated when the traveling motor 10 operates as the regenerative brake will be omitted.

According to such a configuration, the power conversion device 31 converts the voltage of the DC power supplied (discharged) from the battery 20 into an AC voltage boosted by a factor of 3 at most in accordance with the control process of the controller 350 and supplies the AC voltage to the traveling motor 10. That is, the power conversion device 31 supplies an AC voltage EO obtained by accumulating the output voltage E1 output by the rectangular voltage generator 310, the output voltage E2 output by the voltage waveform generator 320, and the output voltage E3 output by the rectangular voltage generator 330 between the phases of the traveling motor 10. Thereby, the traveling motor 10 is supplied with an AC voltage subjected to a final differential synthesis process between the phases (between the terminals) of the traveling motor 10. Even in this case, like the power conversion device 30, the power conversion device 31 can perform a power conversion process in which the deterioration of the power conversion efficiency, the increased loss due to the use of high withstand voltage components, and the deterioration of the parts are limited as compared with the power conversion device 30 using the conventional inverter. That is, the power conversion device 31 can also perform a power conversion process more efficiently than the power conversion device using the conventional inverter.

Moreover, because the power conversion device 31 boosts the voltage of the DC power supplied (discharged) from the battery 20 by a factor of 3, for example, when the voltage value of the AC voltage for driving the traveling motor 10 is 600 [V], the power conversion device 30 requires the battery 20 of 300 [V], whereas the power conversion device 31 can use the battery 20 of 200 [V]. Thus, the power conversion device 31 can perform a power conversion process in which the deterioration of the power conversion efficiency, the increased loss due to the use of high withstand voltage components, and the deterioration of the parts are limited as compared with the power conversion device 30.

In the power conversion device 31 of the above-described modified example, a case where the DC power voltage of the battery 20 is boosted by at most a factor of 3 in the configuration in which the rectangular voltage generator 330 and the switching element S3 are added, in other words, the converter 332 is stacked, has been described. In the power conversion device 30, likewise, it is possible to increase a maximum multiple (set a factor of 4 or more) by which the voltage of the DC power of the battery 20 is further increased by stacking the converter 322 and the switching element. It is only necessary for the configuration, operation, process, and the like of the power conversion device 30 in this case to be equivalent to the configuration, operation, process, and the like of the power conversion device 31 described above.

As described above, the power conversion device 30 and the power conversion device 31 includes at least the power converter 300 (or the power converter 301) having the voltage waveform generator 320 configured to convert DC power supplied (discharged) from the battery 20 into the output voltage E2 of a voltage waveform based on the output waveform profile input or set by the controller 350 and output the output voltage E2; and the rectangular voltage generator 310 configured to perform conversion into the output voltage E1 (the rectangular pulse) of a rectangular voltage waveform in accordance with a control process of the controller 350 and output the output voltage E1. In the power conversion device 30 and the power conversion device 31, the controller 350 controls the generation of a voltage waveform in each power converter 300 (or the power converter 301) in accordance with the request command value of the output power output by the control device 100. At this time, in the power conversion device 30 and the power conversion device 31, the controller 350 generates a voltage command value of output power for allowing the power converter 300 (or the power converter 301) to output the AC power on the basis of the request command value and the voltage value and the current value of the AC power output by the power converter 300 (or the power converter 301). In the power conversion device 30 and the power conversion device 31, the controller 350 inputs or sets the generated voltage command value as an output waveform profile to or in the power converter 300 (or the power converter 301). In the power conversion device 30 and the power conversion device 31, at least the AC voltage EO obtained by waveform-synthesizing the voltage waveform of the output voltage E1 output by the rectangular voltage generator 310 with the voltage waveform of the output voltage E2 output by the voltage waveform generator 320 is supplied between phases of the traveling motor 10 which is a three-phase AC motor.

Meanwhile, as described above, the traveling motor 10 is driven (rotated) with an AC voltage of a sinusoidal wave supplied between the phases when AC voltages EO output by the power converters 300 (or the power converters 301) are differentially synthesized in any two of the three phases. That is, the rotational behavior of the traveling motor 10 is determined by the voltage between phases (between terminals) of the traveling motor 10. Accordingly, even if the voltage applied to each terminal of the traveling motor 10 is offset, i.e., even if the voltage is modulated, the inter-terminal voltage of each phase is not changed and the rotational behavior of the traveling motor 10 is not affected.

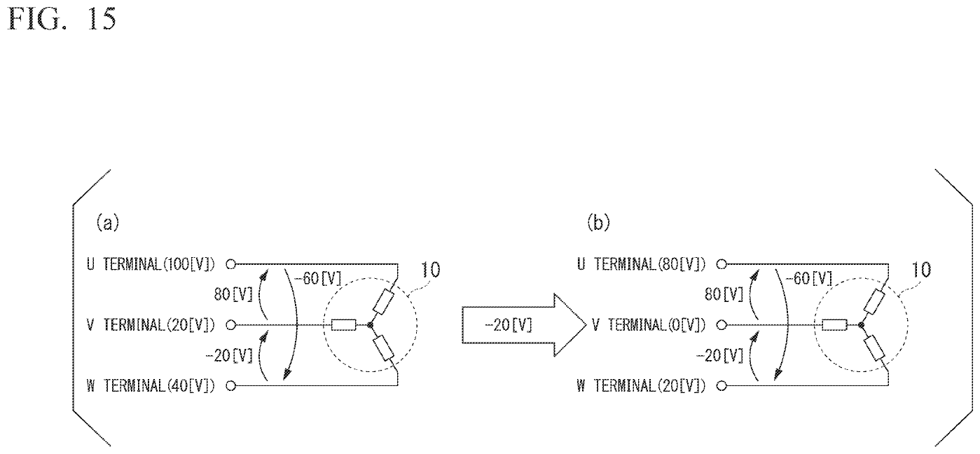

FIG. 15 is a diagram showing a relationship between voltages applied to the traveling motor 10 provided in the vehicle 1. In FIG. 15, a case where a voltage between terminals does not change even if different voltages are applied to the terminals of the traveling motor 10 is schematically shown. More specifically, a case where 100 [V] is applied to the U terminal of the traveling motor 10, 20 [V] is applied to the V terminal, and 40 [V] is applied to the W terminal is shown in (a) of FIG. 15 and a case where an offset voltage of −20 [V] is uniformly added to the voltage applied to each terminal, 80 [V] is applied to the U terminal of the traveling motor 10, 0 [V] is applied to the V terminal, and 20 [V] is applied to the W terminal is shown in (b) of FIG. 15. As shown in (a) of FIG. 15 and (b) of FIG. 15, when the same offset voltage is added, the inter-terminal voltage is the same even if the voltage value applied to each terminal of the traveling motor 10 is different. That is, in both cases of (a) of FIG. 15 and (b) of FIG. 15, the inter-terminal voltage between the U terminal and the V terminal is 80 [V], and the inter-terminal voltage between the V terminal and the W terminal is −20 [V], and the inter-terminal voltage between the W terminal and the U terminal is −60 [V].

Thus, in the power conversion device 30 (including the power conversion device 31), the controller 350 can be configured to generate a voltage command value for enabling the inter-terminal voltage to be secured at a maximum level by performing voltage modulation within a range of the voltage value of the DC voltage E supplied (discharged) from the battery 20. In other words, the controller 350 can be configured to generate a voltage command value such that the battery 20 is supplied (discharged) with a DC voltage of a voltage value having a margin with respect to the voltage value of the DC voltage E.

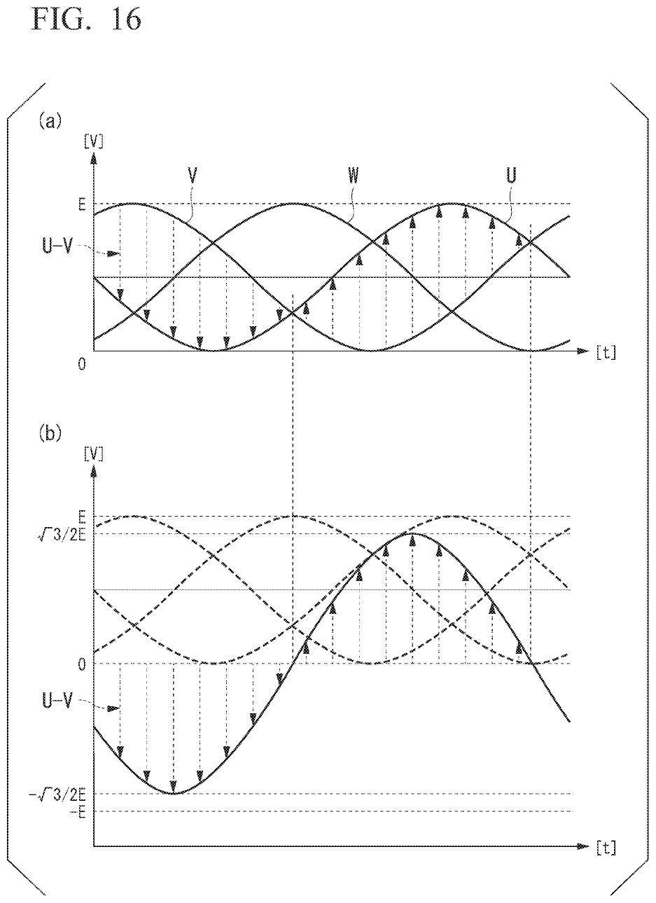

FIG. 16 is a diagram showing a relationship between inter-terminal voltages of the traveling motor 10 provided in the vehicle 1. In FIG. 16, an example of a voltage value that can be provided with a margin by the controller 350 performing voltage modulation is schematically shown. In (a) of FIG. 16, an example of the voltage waveform of the AC voltage EO supplied by the power conversion device 30 to each terminal of the traveling motor 10 is shown. In (b) of FIG. 16, an example of a voltage waveform when voltage modulation has been performed on the AC voltage EO supplied at the U phase of the traveling motor 10 is shown. As described above, in the power conversion device 30, the power converter 300 corresponding to each phase outputs the AC voltage EO that is modulated (phase-modulated) such that the phase is shifted by 120° in the same voltage waveform as shown in (a) of FIG. 16. Thus, the voltage value of the AC voltage EO supplied at the U phase is represented by the following Eq. (1), the voltage value of the AC voltage EO supplied at the V phase is represented by the following Eq. (2), and the voltage value of the AC voltage EO supplied at the W phase is represented by the following Eq. (3).

U=−E/2 sin(ωt)+E/2 (1)

V=−E/2 sin(ωt−2π/3)+E/2 (2)

W=−E/2 sin(ωt+2π/3)+E/2 (3)

Here, focusing on the inter-terminal voltage U-V between the AC voltage EO supplied at the U phase and the AC voltage EO supplied at the V phase shown in (a) of FIG. 16, the inter-terminal voltage U-V is indicated by a shaded area in (a) of FIG. 16 and has a different phase (see (b) of FIG. 16), but has the voltage waveform of the sinusoidal wave represented by the following Eq. (4).

$$U - V = - E / 2 * ( sin ( ω t ) - sin ( ω t - 2 π / 3 ) ) = - E / 2 * 2 * sin ( π / 3 ) * cos ( ω t - π / 3 ) = - √ 3 / 2 * E * cos ( ω t - π / 3 ) \qquad ( 4 )$$

Thus, it can be seen that voltage modulation can be performed such that the voltage value has a margin within a range of the voltage value of the DC voltage E supplied (discharged) from the battery 20 like the inter-terminal voltage shown in the shaded area in (b) of FIG. 16 in the power conversion device 30. More specifically, assuming that the voltage value of the DC voltage E that can be supplied from the battery 20 is E [V], it can be seen that the maximum width (the maximum range) of the inter-terminal voltage U-V has a range of the following Eq. (5).

√3/2*E≈0.866*E (5)

From the above Eq. (5), it can be seen that the controller 350 can generate a voltage command value for supplying (discharging) a DC voltage of a voltage value having a margin with respect to the maximum voltage value of the DC voltage E to the battery 20 without distorting the voltage waveform if the voltage is modulated after a maximum value of the inter-terminal voltage U-V is calculated as a value increased by a factor of 2/√3 instead of the DC voltage E. That is, it can be seen that the controller 350 can expand (improve) the voltage utilization rate of the battery 20 by a factor of 2√3≈1.154 by performing voltage modulation. In other words, it can be seen that the voltage utilization rate expansion effect of 15.4% can be obtained when the controller 350 performs the voltage modulation.

### Configuration of Voltage Modulation

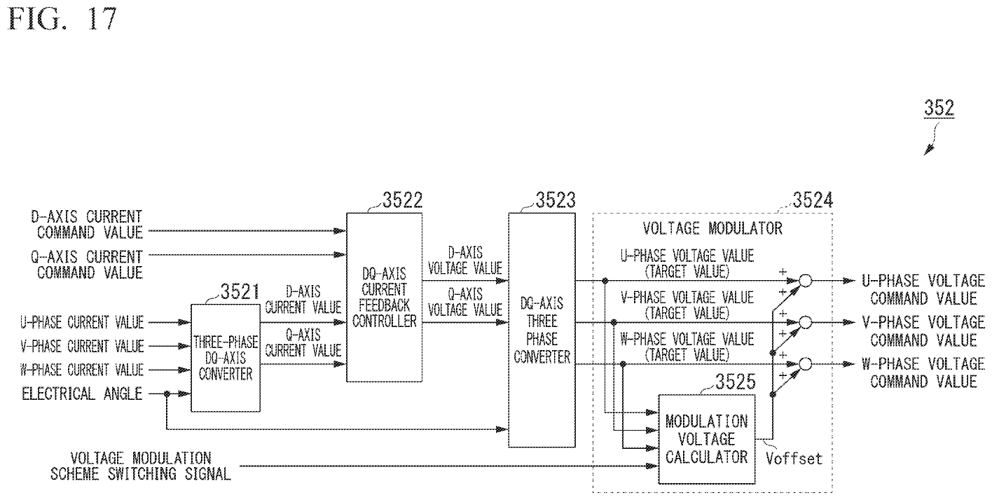

Here, an example of a configuration in which the controller 350 (more specifically, the voltage command value determiner 352) generates a voltage modulation (hereinafter referred to as “voltage utilization rate expansion modulation”)-specific voltage command value will be described. FIG. 17 is a diagram showing an example of a functional configuration of the voltage command value determiner 352 provided in the controller 350. The voltage command value determiner 352 includes, for example, a three-phase DQ-axis converter 3521, a DQ-axis current feedback controller 3522, a DQ-axis three-phase converter 3523, and a voltage modulator 3524. The voltage modulator 3524 includes, for example, a modulation voltage calculator 3525.

The three-phase DQ-axis converter 3521 converts a U-phase current value, a V-phase current value, and a W-phase current value included in acquired phase current information and their electrical angles (phases of phase currents) into a D-axis current value and a Q-axis current value. The three-phase DQ-axis converter 3521 outputs information of the D-axis current value and the Q-axis current value after the conversion to the DQ-axis current feedback controller 3522.

The DQ-axis current feedback controller 3522 performs feedback control on the basis of a D-axis current command value and a Q-axis current command value included in the acquired request command value and the D-axis current value and the Q-axis current value obtained in the conversion process of the three-phase DQ-axis converter 3521. The DQ-axis current feedback controller 3522 generates a D-axis voltage value and a Q-axis voltage value according to the feedback control. The DQ-axis current feedback controller 3522 outputs information of the generated D-axis voltage value and the generated Q-axis voltage value to the DQ-axis three-phase converter 3523. The feedback control in the DQ-axis current feedback controller 3522 is, for example, PID control. The feedback control in the DQ-axis current feedback controller 3522 is not limited to the PID control, and may be another feedback control method.

The DQ-axis three-phase converter 3523 converts the D-axis voltage value and the Q-axis voltage value generated by the DQ-axis current feedback controller 3522 into a U-phase voltage value, a V-phase voltage value, and a W-phase voltage value on the basis of electrical angles of the current values of the phases included in the acquired phase current information. Each of the U-phase voltage value, the V-phase voltage value, and the W-phase voltage value obtained in the conversion process of the DQ-axis three-phase converter 3523 is a target value of an AC voltage supplied to each phase of the traveling motor 10 (applied to each terminal thereof). The DQ-axis three-phase converter 3523 outputs information of the U-phase voltage value, the V-phase voltage value, and the W-phase voltage value obtained in the conversion process to the voltage modulator 3524.

The above-described configuration is similar to the configuration of a general control device that controls the motor.

The voltage modulator 3524 generates a U-phase voltage command value, a V-phase voltage command value, and a W-phase voltage command value on the basis of the U-phase voltage value, the V-phase voltage value, and the W-phase voltage value obtained in the conversion process of the DQ-axis three-phase converter 3523. At this time, the voltage modulator 3524 generates the U-phase voltage command value, the V-phase voltage command value, and the W-phase voltage command value by adding an offset voltage value Voffset generated by the modulation voltage calculator 3525 to each of the U-phase voltage value, the V-phase voltage value, and the W-phase voltage value.

The modulation voltage calculator 3525 generates the offset voltage value Voffset for enabling the voltage modulator 3524 to generate each of the U-phase voltage command value, the V-phase voltage command value, and the W-phase voltage command value on the basis of the U-phase voltage value, the V-phase voltage value, and the W-phase voltage value obtained in the conversion process of the DQ-axis three-phase converter 3523.

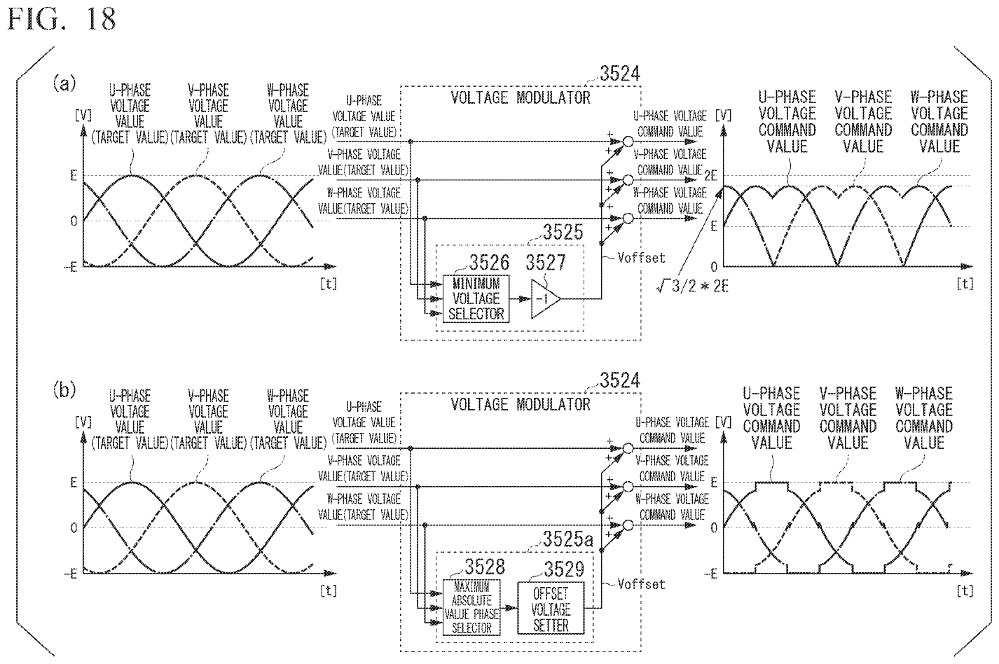

Here, an example of a more detailed configuration of the modulation voltage calculator 3525 will be described. FIG. 18 is a diagram showing an example of a functional configuration of the voltage modulator 3524 provided in the voltage command value determiner 352. In (a) of FIG. 18, an example of a more detailed functional configuration of the modulation voltage calculator 3525 provided in the voltage modulator 3524 is shown. In (b) of FIG. 18, an example of a more detailed functional configuration of the modulation voltage calculator 3525 when each of the U-phase voltage command value, the V-phase voltage command value, and the W-phase voltage command value output to the conventional inverter is generated is shown as reference. In (a) of FIG. 18 and (b) of FIG. 18, an example of each of the input target values (the U-phase voltage value, the V-phase voltage value, and the W-phase voltage value) and the output voltage command values (the U-phase voltage command value, the V-phase voltage command value, and the W-phase voltage command value) is schematically shown as a voltage waveform.

First, a functional configuration of the modulation voltage calculator 3525 provided in the voltage modulator 3524 will be described with reference to (a) of FIG. 18. The modulation voltage calculator 3525 includes, for example, a minimum voltage selector 3526 and an offset voltage calculator 3527.

The minimum voltage selector 3526 selects a minimum voltage value from the U-phase voltage value, the V-phase voltage value, and the W-phase voltage value output by the DQ-axis three-phase converter 3523. The minimum voltage selector 3526 outputs the selected minimum voltage value to the offset voltage calculator 3527.

The offset voltage calculator 3527 sets a voltage value obtained by multiplying the minimum voltage value output by the minimum voltage selector 3526 by “−1” to the offset voltage value Voffset. The offset voltage calculator 3527 outputs the offset voltage value Voffset to the voltage modulator 3524.

Thereby, the voltage modulator 3524 adds the offset voltage value Voffset to each of the U-phase voltage value, the V-phase voltage value, and the W-phase voltage value, which are the target values of the AC voltage supplied at the phases of the traveling motor 10 (substantially subtracts the offset voltage value Voffset therefrom because the offset voltage value Voffset is a negative (minus) voltage value), and generates each of the U-phase voltage command value, the V-phase voltage command value, and the W-phase voltage command value.

According to such a configuration, as shown in (a) of FIG. 18, the voltage modulator 3524 generates a voltage command value indicated by a voltage waveform in which a peak voltage value is limited to a smaller value in a half wave of a sinusoidal wave using 0 [V] as a reference voltage by performing voltage utilization rate expansion modulation when a continuous sinusoidal wave having a voltage value between E [V] and −E [V] has been input as a target value. In the voltage command value indicated by the voltage waveform as shown in (a) of FIG. 18, the peak voltage value of the voltage command value is limited to a value smaller than the voltage value=2E [V] that is twice the DC voltage E. More specifically, the voltage command value indicated by the voltage waveform as shown in (a) of FIG. 18 is a voltage command value that changes in the range of 0 [V] to √3/2*2E [V].

Subsequently, a functional configuration of the modulation voltage calculator 3525 (hereinafter referred to as a “modulation voltage calculator 3525a”) in the case where the voltage modulator 3524 is configured to generate a voltage command value for the conventional inverter will be described with reference to (b) of FIG. 18. The modulation voltage calculator 3525a includes, for example, a maximum absolute value phase selector 3528 and an offset voltage setter 3529.

The maximum absolute value phase selector 3528 selects a voltage value of a phase having a maximum absolute value from the U-phase voltage value, the V-phase voltage value, and the W-phase voltage value output by the DQ-axis three-phase converter 3523. The maximum absolute value phase selector 3528 outputs the selected voltage value of the phase having the maximum absolute value to the offset voltage setter 3529.

The offset voltage setter 3529 sets the offset voltage value Voffset on the basis of the voltage value of the phase having the maximum absolute value output by the maximum absolute value phase selector 3528. More specifically, the offset voltage setter 3529 sets, for example, a voltage value that is half the DC voltage value of the DC voltage E capable of being supplied from the battery 20, as a reference value (assumed to be a reference value Lm here). When the voltage value (assumed to be the voltage value Zx here) of the phase whose absolute value is a voltage value of a phase having a maximum absolute value output by the maximum absolute value phase selector 3528 is a positive (plus) value, the offset voltage setter 3529 sets the reference value Lm to a positive value and sets a voltage value (=Lm−Zx) obtained by subtracting the voltage value Zx from the reference value Lm as the offset voltage value Voffset. On the other hand, when the voltage value Zx is a negative (minus) value, the offset voltage setter 3529 sets the reference value Lm to a negative value and sets the voltage value (=−Lm−Zx) obtained by subtracting the voltage value Zx from the reference value Lm as the offset voltage value Voffset. The offset voltage setter 3529 outputs the set offset voltage value Voffset to the voltage modulator 3524.

Thereby, the voltage modulator 3524 adds the offset voltage value Voffset to each of the U-phase voltage value, the V-phase voltage value, and the W-phase voltage value, which are target values of the AC voltage supplied at phases of the traveling motor 10 and generates each of the U-phase voltage command value, the V-phase voltage command value, and the W-phase voltage command value.

According to such a configuration, as shown in (b) of FIG. 18, the voltage modulator 3524 generates a voltage command value indicated by a voltage waveform in which a positive and negative peak voltage value of a sinusoidal wave is fixed to E [V] that is a positive maximum value or −E [V] that is a negative maximum value during a certain period when a continuous sinusoidal wave having a voltage value between E [V] and −E [V] similar to that in (a) of FIG. 18 has been input as a target value. It is possible to stop an operation of the arm of an upper side (a positive side) or a lower side (a negative side) constituting the conventional inverter during a certain period in which the voltage command value indicated by the voltage waveform as shown in (b) of FIG. 18 is fixed to E [V] or −E [V]. Thereby, the voltage command value indicated by the voltage waveform as shown in (b) of FIG. 18 has a balance (a thermal balance) of a heat generation amount generated when the upper and lower arms constituting the conventional inverter operate and the efficiency of the power supply system can be improved.

Returning to FIG. 17, the voltage modulator 3524 outputs information of each of the U-phase voltage command value, the V-phase voltage command value, and the W-phase voltage command value generated by performing the voltage utilization rate expansion modulation as the voltage command value decided on by the voltage command value determiner 352 to the output waveform profile determiner 354. Thereby, in the controller 350, as described above, the output waveform profile determiner 354 decides on an output waveform profile to be set in the converter 322 on the basis of the voltage command value decided on by the voltage command value determiner 352 and the switching controller 356 controls each switching element provided in the power converter 300 and the rectangular voltage generator 310 on the basis of the voltage command value decided on by the voltage command value determiner 352.

In the above description, the modulation voltage calculator 3525 provided in the voltage modulator 3524 has been described as having the configuration shown in (a) of FIG. 18. However, the configuration of the modulation voltage calculator 3525 is not limited to the configuration shown in (a) of FIG. 18. The function of the modulation voltage calculator 3525 is also not limited to the function described with reference to (a) of FIG. 18. For example, the modulation voltage calculator 3525 includes a plurality of functions such as the function of the modulation voltage calculator 3525 shown in (a) of FIG. 18 and the function of the modulation voltage calculator 3525a shown in (b) of FIG. 18. For example, the controller 350 may be configured to switch (select) the function to be used when the power converter 300 is controlled. The functional configuration of the voltage command value determiner 352 shown in FIG. 17 is a configuration in which a voltage modulation scheme switching signal is input to the modulation voltage calculator 3525 as a means for switching the function of the modulation voltage calculator 3525.

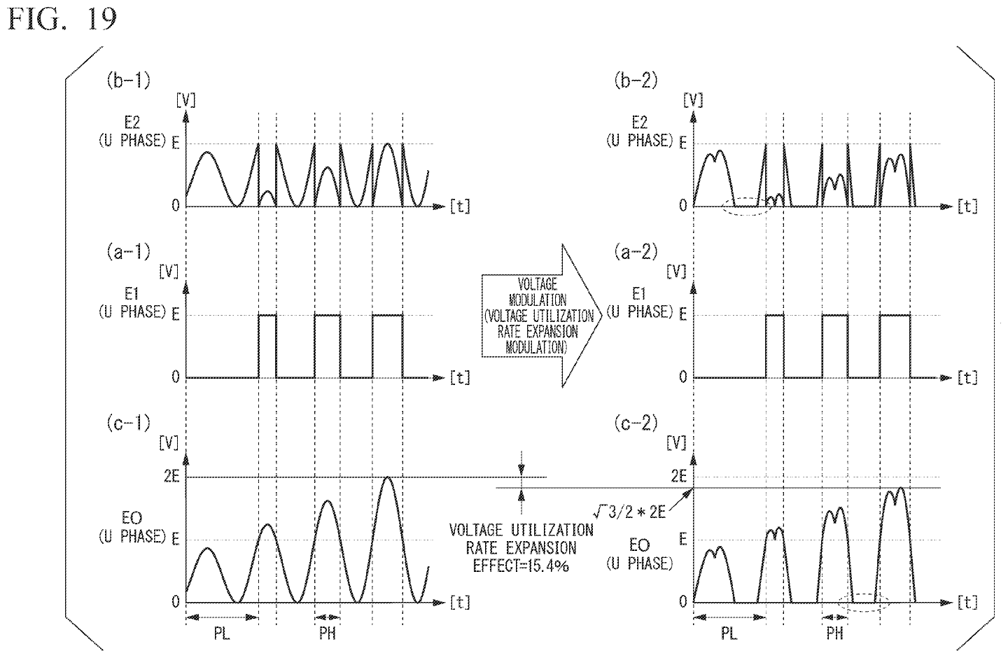

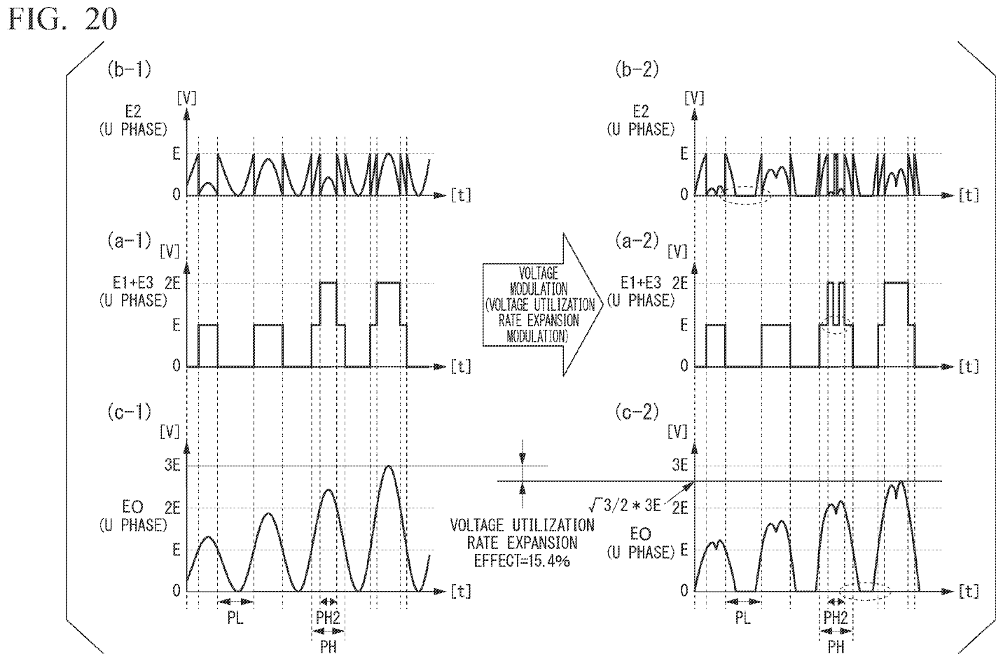

Here, the voltage waveforms generated by the power conversion device 30 and the power conversion device 31 when the controller 350 has performed voltage utilization rate expansion modulation will be described. FIG. 19 is a diagram showing an example of a voltage waveform generated when voltage modulation (voltage utilization rate expansion modulation) has been performed in the power conversion device 30. FIG. 20 is a diagram showing an example of a voltage waveform generated when voltage modulation (voltage utilization rate expansion modulation) has been performed in the power conversion device 31 of the modified example.

First, a voltage waveform generated by the power conversion device 30 when the controller 350 has performed voltage utilization rate expansion modulation will be described with reference to FIGS. 19. (a-1) to (c-1) of FIG. 19 show examples of the voltage waveform of the output voltage generated by the power converter 300U provided in the power conversion device 30, i.e., examples of the voltage waveform described with reference to FIG. 4, when the controller 350 has not performed voltage utilization rate expansion modulation. (a-2) to (c-2) of FIG. 19 show examples of the voltage waveform of the output voltage generated by the power converter 300U provided in the power conversion device 30 when the controller 350 has performed voltage utilization rate expansion modulation.

As can be seen by comparing (a-1) of FIG. 19 with (a-2) of FIG. 19, the output voltage E1 generated and output by the rectangular voltage generator 310 provided in the power converter 300U is the same regardless of whether or not the controller 350 has performed voltage utilization rate expansion modulation. On the other hand, as can be seen by comparing (b-1) of FIG. 19 with (b-2) of FIG. 19, in the output voltage E2 generated and output by the voltage waveform generator 320 provided in the power converter 300U, a peak voltage value is limited to a small value as the peak voltage value of the voltage command value (the output waveform profile) input or set by the controller 350 is limited to a small value when the controller 350 has performed voltage utilization rate expansion modulation. More specifically, in the output voltage E2 shown in (b-2) of FIG. 19, a voltage value of a position where the AC voltage value of the AC voltage EO in which the voltage waveform of the output voltage E1 and the voltage waveform of the output voltage E2 are waveform-synthesized becomes a peak value is limited to a small value. Thereby, as can be seen by comparing (c-1) of FIG. 19 with (c-2) of FIG. 19, a peak voltage value in the AC voltage value of the AC voltage EO in which the voltage waveform of the output voltage E1 and the voltage waveform of the output voltage E2 are waveform-synthesized is limited to a small value. More specifically, the peak voltage value in the AC voltage value of the AC voltage EO is limited to a small value in √3/2*2E [V]. Thereby, in the power conversion device 30, the controller 350 performs voltage modulation, such that the voltage utilization rate expansion effect of 15.4% can be obtained.

Meanwhile, as can be seen by comparing (b-1) of FIGS. 19 and (b-2) of FIG. 19 or (c-1) of FIGS. 19 and (c-2) of FIG. 19, when the controller 350 has performed the voltage utilization rate expansion modulation, for example, during a period circled by a broken line in (b-2) of FIG. 19 or (c-2) of FIG. 19, the voltage value of the output voltage E2 or the AC voltage value of the AC voltage EO becomes 0 [V]. These periods correspond to a period in which the operation of the converter 322 provided in the voltage waveform generator 320 is stopped in the power conversion device 30. During these periods, for example, the controller 350 may be configured to set the switching element S2R provided in the rectangular voltage generator 310 in the conductive state and output 0 [V] instead of the converter 332. From this, when the controller 350 has performed voltage utilization rate expansion modulation, the power conversion device 30 can also limit heat generation in the converter 322 and improve the efficiency of the power supply system as in a case where the thermal balance is taken when the upper and lower arms constituting the conventional inverter described above operate. However, a control process based on such a voltage command value (a voltage command value indicated by the voltage waveform shown in (a) of FIG. 18) cannot be performed with respect to the conventional inverter. This is because the voltage command value indicated by the voltage waveform shown in (a) of FIG. 18 is only in a period of 0 [V]. More specifically, this is because the positive maximum value or the negative maximum value is alternately fixed like the voltage command value for the conventional inverter indicated by the voltage waveform shown in (b) of FIG. 18, such that it is not possible to perform a control process of alternately stopping the operations of the upper and lower arms and it is possible to perform a control process of stopping the operation of only one arm.

Subsequently, a voltage waveform generated by the power conversion device 31 when the controller 350 has performed voltage utilization rate expansion modulation will be described with reference to FIGS. 20. (a-1) to (c-1) of FIG. 20 are examples of the voltage waveform of the output voltage generated by the power converter 301U provided in the power conversion device 31, i.e., examples of the voltage waveform described with reference to FIG. 12, when the controller 350 has not performed voltage utilization rate expansion modulation. (a-2) to (c-2) of FIG. 20 show examples of the voltage waveform of the output voltage generated by the power converter 301U provided in the power conversion device 31 when the controller 350 has performed voltage utilization rate expansion modulation. However, in (a-1) and (a-2) of FIG. 20, a state in which the voltage waveform of the output voltage E1 output by the rectangular voltage generator 310 provided in the power converter 301U and the voltage waveform of the output voltage E3 output by the rectangular voltage generator 330 are waveform-synthesized is shown.

As can be seen by comparing (a-1) of FIG. 20 with (a-2) of FIG. 20, even in the power conversion device 31, the output voltage E1 generated and output by the rectangular voltage generator 310 provided in the power converter 301U is the same regardless of whether or not the controller 350 has performed voltage utilization rate expansion modulation. As can be seen by comparing (b-1) of FIG. 20 with (b-2) of FIG. 20, even in the power conversion device 31, in the output voltage E2 generated and output by the voltage waveform generator 320 provided in the power converter 301U, a peak voltage value is limited to a small value when the controller 350 has performed voltage utilization rate expansion modulation. Thus, even in the power conversion device 31, the efficiency of the power supply system can be improved during the period circled by the broken line in (b-2) of FIG. 20 or (c-2) of FIG. 20. Further, in the power conversion device 31, when the controller 350 has performed voltage utilization rate expansion modulation, the output of the output voltage E3 output by the rectangular voltage generator 330 provided in the power converter 301U is also limited during the period circled by the broken line in (a-2) of FIG. 20. That is, the rectangular voltage generator 330 has stopped the operation of the converter 332. The concept of improving the efficiency of the power supply system during the period when the components provided in the power converter 301 are stopped is similar to the concept in the power conversion device 30 described above. Thereby, even in the power conversion device 31, the controller 350 performs voltage modulation, such that the peak voltage value of the AC voltage value of the AC voltage EO is limited to a small value in √3/2*3E [V] and a voltage utilization rate expansion effect of 15.4% can be obtained.

As described above, the power conversion device of each embodiment includes the power converter 300 having at least the voltage waveform generator 320 configured to convert DC power supplied (discharged) from the battery 20 into the output voltage E2 of a voltage waveform based on the output waveform profile input or set by the controller 350 and output the output voltage E2; and the rectangular voltage generator 310 configured to perform conversion into the output voltage E1 (the rectangular pulse) of a rectangular voltage waveform in accordance with a control process of the controller 350 and output the output voltage E1. In the power conversion device of each embodiment, the controller 350 controls the generation of the voltage waveform in each power converter 300 in accordance with the request command value of the output power output by the control device 100. At this time, in the power conversion device of each embodiment, the controller 350 generates the voltage command value of the output power for allowing the power converter 300 to output the AC power on the basis of the request command value and the voltage value and the current value of the AC power output by the power converter 300. In the power conversion device of each embodiment, the controller 350 inputs or sets the generated voltage command value as the output waveform profile to or in the power converter 300. In the power conversion device of each embodiment, the AC voltage EO obtained by waveform-synthesizing the voltage waveform of the output voltage E1 output by the rectangular voltage generator 310 and the voltage waveform of the output voltage E2 output by the voltage waveform generator 320 is supplied between the phases of the traveling motor 10 that is a three-phase AC motor. Thereby, the power conversion device of each embodiment can efficiently perform power conversion in which the deterioration of the power conversion efficiency, the increase in the loss due to the use of a high withstand voltage component, and the deterioration of the component are limited as compared with the power conversion device using the conventional inverter. Further, in the power conversion device of each embodiment, the controller 350 performs the voltage utilization rate expansion modulation, such that the peak voltage value of the AC voltage value of the AC voltage EO is limited to a small value and the voltage utilization rate expansion effect can be obtained. The AC voltages EO output by the power conversion devices of the embodiments are differentially synthesized in any two of the three phases and the traveling motor 10 is driven (rotated) with the AC voltage of the sinusoidal wave supplied between the phases.

The power conversion device of each embodiment described above includes the power converter 300 including at least the voltage waveform generator 320 for converting battery power (the DC voltage E) output by the battery 20 into the output voltage E2 of a first voltage waveform based on an input or set output waveform profile and outputting the output voltage E2 from the third end g and the fourth end h and the rectangular voltage generator 310 for converting the battery power into the output voltage E1 of a second voltage waveform of a rectangular shape and outputting the output voltage E1 from the third end c and the fourth end d and configured to supply the load LD (the traveling motor 10) with the AC voltage EO of an AC control waveform generated by adding the output voltage E2 to the output voltage E1; and the controller 350 configured to output a voltage command value for outputting the output voltage E2 as the output waveform profile to the voltage waveform generator 320 to the power converter 300 on the basis of an input request command value of output power for the load LD (the traveling motor 10) and a voltage value of the AC voltage EO output by the power converter 300, whereby preferred power conversion associated with the battery 20 suitable for characteristics of traveling of the vehicle 1 can be performed. Thereby, the power conversion device of each embodiment can limit the deterioration of the conversion efficiency, the increase in the loss due to the use of a high withstand voltage component, and the deterioration of the component when DC power is converted into AC power as compared with the power conversion device using the conventional inverter and efficiently perform power conversion. Thereby, in the vehicle 1 equipped with the power conversion device of each embodiment, the mileage can be extended, the durability can be improved, and the commercial value of the vehicle 1 can be enhanced. From these facts, the vehicle 1 equipped with the power conversion device of each embodiment is expected to contribute to improving energy efficiency and reducing adverse effects on the global environment.

In each of the above-described embodiments, the configuration in which the controller 350 controls the operation of the power conversion device has been described. However, the control device 100 provided in the vehicle 1 may control the operation of the power conversion device. It is only necessary for the configuration, operation, process, and the like of the control device 100 in this case to be equivalent to the configuration, operation, process, and the like of the controller 350 of each of the above-described embodiments.

The embodiment described above can be represented as follows.

A power conversion device including a control device for controlling a power converter including at least a first converter for converting battery power output by a battery into first output power of a first voltage waveform based on an input or set output waveform profile and outputting the first output power from a first terminal pair and a second converter for converting the battery power into second output power of a second voltage waveform of a rectangular shape and outputting the second output power and configured to supply a load with third output power of an AC control waveform generated by adding the first output power to the second output power, the control device including:

a hardware processor, and

a storage device storing a program,

wherein the hardware processor reads and executes the program stored in the storage device to:

output a voltage command value for outputting the first output power as the output waveform profile to the first converter to the power converter on the basis of an input request command value of output power for the load and a voltage value of the third output power output by the power converter.

Although modes for carrying out the present invention have been described above using embodiments, the present invention is not limited to the embodiments and various modifications and substitutions can be made without departing from the scope and spirit of the present invention.

What is claimed is:

1. A power conversion device comprising:
a power converter including at least a first converter for converting battery power output by a battery into first output power of a first voltage waveform based on an input or set output waveform profile and outputting the first output power from a first terminal pair and a second converter for converting the battery power into second output power of a second voltage waveform of a rectangular shape and outputting the second output power from a second terminal pair and configured to supply a load with third output power of an alternating current (AC) control waveform generated by adding the first output power to the second output power; and
a controller configured to output a voltage command value for outputting the first output power as the output waveform profile to the first converter to the power converter on the basis of an input request command value of output power for the load and a voltage value of the third output power output by the power converter.

2. The power conversion device according to claim 1, wherein the first voltage waveform is a voltage waveform obtained by subtracting the second voltage waveform from the control waveform represented by a sinusoidal wave having a positive value.

3. The power conversion device according to claim 2,
wherein the power converter supplies the third output power from a portion between one end of the first terminal pair and one end of the second terminal pair to the load, and
wherein the power converter further includes a first switching element connected between another end of the first terminal pair and another end of the second terminal pair and the one end of the first terminal pair and configured to enable or disable the supply of electric power supplied from the load to the first converter and the second converter.

4. The power conversion device according to claim 3, wherein the second converter is a half-bridge type converter including:
a second switching element connected between the battery and the another end of the second terminal pair and configured to enable or disable the supply of the battery power as the second output power to the load; and
a third switching element connected between the one end of the second terminal pair and the another end of the second terminal pair and configured to enable or disable the supply of the second output power to the first converter.

5. The power conversion device according to claim 4,
wherein the power converter further includes a third converter connected to the first converter and the second converter in parallel and configured to convert the battery power into fourth output power of a third voltage waveform of a rectangular shape and output the fourth output power from a third terminal pair,
wherein the first voltage waveform is a voltage waveform from which the third voltage waveform is subtracted, and
wherein the third output power generated by adding the first output power and the second output power to the fourth output power is supplied to the load.

6. The power conversion device according to claim 5,
wherein the power converter supplies the third output power from a portion between the one end of the second terminal pair and one end of the third terminal pair to the load, and
wherein the power converter further includes a fourth switching element connected between the one end of the first terminal pair and another end of the third terminal pair and the one end of the third terminal pair and the first switching element and configured to enable or disable the supply of electric power supplied from the load to the first converter and the third converter.

7. The power conversion device according to claim 1,
wherein the load is a star-connected three-phase load,
wherein the power conversion device includes three power converters configured to supply the third output power to each corresponding phase of the load,
wherein the power converters have one ends of second terminal pairs connected to each other, and
wherein the controller outputs the voltage command value for outputting the third output power of the control waveform that is modulated such that a phase is shifted by 120° to the first converter provided in the power converter corresponding to each phase as the output waveform profile to the power converter.

8. The power conversion device according to claim 7,
wherein the controller selects a minimum voltage value among voltage values of third output powers corresponding to phases,
wherein the controller performs a modulation process in which 0 [V] is a reference modulation voltage value by designating a voltage value obtained by multiplying the selected minimum voltage value by −1 as an offset voltage value and adding the offset voltage value to a voltage value of the third output power, and
wherein the controller outputs the voltage command value indicating the modulation voltage value as the output waveform profile to the power converter.

9. A method of controlling a power conversion device having a power converter including at least a first converter for converting battery power output by a battery into first output power of a first voltage waveform based on an input or set output waveform profile and outputting the first output power from a first terminal pair and a second converter for converting the battery power into second output power of a second voltage waveform of a rectangular shape and outputting the second output power from a second terminal pair and configured to supply a load with third output power of an alternating current (AC) control waveform generated by adding the first output power to the second output power, the method comprising;
outputting, by a computer, a voltage command value for outputting the first output power as the output waveform profile to the first converter to the power converter on the basis of an input request command value of output power for the load and a voltage value of the third output power output by the power converter.

10. A non-transitory computer-readable storage medium storing a program for controlling a power converter including at least a first converter for converting battery power output by a battery into first output power of a first voltage waveform based on an input or set output waveform profile and outputting the first output power from a first terminal pair and a second converter for converting the battery power into second output power of a second voltage waveform of a rectangular shape and outputting the second output power from a second terminal pair and configured to supply a load with third output power of an alternating current (AC) control waveform generated by adding the first output power to the second output power, the program causing a computer to:
output a voltage command value for outputting the first output power as the output waveform profile to the first converter to the power converter on the basis of an input request command value of output power for the load and a voltage value of the third output power output by the power converter.
